(19) United States
(12) Patent Application Publication
(10) Pub. No.: US 2026/0186553 A1
(43) Pub. Date: Jul. 2, 2026

(54) METHOD OF RUNNING APPLICATION, APPARATUS, ELECTRONIC DEVICE AND STORAGE MEDIUM

(71) Applicant: Samsung Electronics Co., Ltd., Suwon-si (KR)

(72) Inventors: Mujun ZHANG, Guangzhou (CN); Zhongmin HUANG, Guangzhou (CN); Xiaojun QIN, Guangzhou (CN); Kaiming CHEN, Guangzhou (CN)

(21) Appl. No.: 19/544,567

(22) Filed: Feb. 19, 2026

Related U.S. Application Data
(63) Continuation of application No. PCT/IB2024/060070, filed on Oct. 15, 2024.

(30) Foreign Application Priority Data
Oct. 26, 2023 (CN) 202311408380.8

(51) Int. Cl. G06F 1/3234; G09G 3/36; G09G 5/14

(52) U.S. Cl. CPC G06F 1/3265; G09G 3/36; G09G 5/14; G09G 2320/0613; G09G 2320/10; G09G 2330/021; G09G 2340/0435; G09G 2340/125

(57) ABSTRACT

A method of running an application, an apparatus, an electronic device and a storage medium are provided. The method includes determining a target application for improving power consumption and a target layer of the target application for improving refresh rate, identifying a type of the target layer based on a decision tree model, adjusting a refresh rate value of the target layer based on the type of the target layer corresponding to a power consumption adjustable layer, determining a refresh rate value of a terminal screen based on the adjusted refresh rate value of the target layer, and running the target application based on the refresh rate value of the terminal screen. Furthermore, an artificial intelligence model may also be used to perform the above method of running an application.

### CROSS-REFERENCE TO RELATED APPLICATION(S)

This application is a continuation application, claiming priority under 35 U.S.C. § 365(c), of an International application No. PCT/IB2024/060070, filed on Oct. 15, 2024, which is based on and claims the benefit of a Chinese patent application number 202311408380.8, filed on Oct. 26, 2023, in the Chinese Intellectual Property Office, the disclosure of which is incorporated by reference herein in its entirety.

### BACKGROUND

### 1. Field

The disclosure relates to a computer technology field. More particularly, the disclosure relates to a method of running an application, an apparatus, an electronic device and a storage medium.

### 2. Description of Related Art

When a terminal is in an adaptive refresh rate mode, a refresh rate of a system, i.e., a refresh rate of a terminal screen, is determined by a refresh speed (frame per second, fps) and an area weight of each of multiple layers contained in an application (APP). For example, when the area weights of the multiple layers contained in the APP meets a preset requirement, and the refresh speeds of the multiple layers contained in the APP are not consistent, the refresh rate of the system generally takes the highest value among the multiple refresh speeds. For example, the refresh speeds of most video sources themself may be less than 30 frames per second, while the refresh speed of barrage scrolling of certain software may be as high as 120 frames per second, in a case where the area weights of a video layer and a barrage layer both satisfy the preset condition, it will be forced to maintain the refresh rate of the system at 120 frames per second, while in fact, there is no need for the video to be played to have such a high refresh rate at all. At the same time, because the refresh rate of the system is forced to be high, the terminal will be operated at a high current, which will lead to a substantial increase in the power consumption of the terminal, resulting in an excessive waste of resources.

In the related technology, in order to avoid the waste of resources caused by the increase in power consumption of the terminal, the main method is that developers test different APPs and then manually force the refresh rate of each APP to a lower value on a server side. However, this method requires the developers to test different APPs one by one and set the corresponding refresh rate for different APPs one by one on the server side, which makes the workload of setting the refresh rate larger and more cumbersome, and is not intelligent enough.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method of running an application, an apparatus, an electronic device and a storage medium.

In accordance with another aspect of the disclosure, a method of running an application is provided. The method includes determining a target application for improving power consumption and a target layer of the target application for improving refresh rate, identifying a type of the target layer based on a decision tree model, adjusting a refresh rate value of the target layer based on the type of the target layer corresponding to a power consumption adjustable layer, determining a refresh rate value of a terminal screen based on the adjusted refresh rate value of the target layer, and running the target application based on the refresh rate value of the terminal screen.

Alternatively, the adjusting the refresh rate value of the target layer includes adjusting the refresh rate value of the target layer based on at least one of a center position relationship between the target layer and the terminal screen, an area relationship between the target layer and the terminal screen, and the type of the target layer.

Alternatively, the adjusting the refresh rate value of the target layer includes determining a preset minimum refresh rate value corresponding to the target layer based on at least one of the center position relationship between the target layer and the terminal screen, the area relationship between the target layer and the terminal screen, and the type of the target layer, adjusting the refresh rate value of the target layer based on the preset minimum refresh rate value corresponding to the target layer and an actual sampled refresh rate value of the target layer.

Alternatively, after running the target application based on the refresh rate value of the terminal screen, the method further includes obtaining power consumption and performance state data of the terminal, optimizing, by a reinforcement learning model, the refresh rate value of the target layer based on the power consumption and the performance state data of the terminal, determining an optimized refresh rate value of the terminal screen based on the optimized refresh rate value of the target layer, running the target application based on the optimized refresh rate value of the terminal screen.

Alternatively, the optimizing, by the reinforcement learning model, the refresh rate value of the target layer based on the power consumption and the performance state data of the terminal includes optimizing the refresh rate value of the target layer based on the power consumption and the performance state data of the terminal and a preset state action table of the reinforcement learning model, to obtain the optimized refresh rate value of the target layer, wherein the preset state action table includes a plurality of states, each of the states corresponds to a plurality of refresh rate adjusting action types, and each of the refresh rate adjusting action types corresponds to a respective state action penalty value.

Alternatively, the determining the refresh rate value of the terminal screen based on the adjusted refresh rate value of the target layer includes determining the refresh rate value of the terminal screen based on the adjusted refresh rate value of the target layer and actual sampled refresh rate value(s) of other layer(s) included in the target application.

Alternatively, the determining the target application for improving power consumption includes obtaining historical behavioral characteristic data of foreground running of each application installed within the terminal, determining, as the target application, an application whose historical behavioral characteristic data is outside a predetermined range.

Alternatively, the determining the target layer of the target application for improving refresh rate includes obtaining, while the target application is running, running behavioral characteristic data of the target application, determining, based on the running behavioral characteristic data being outside a preset range, an application layer of the highest actual sampled refresh rate value among a plurality of application layers included in the target application as the target layer.

Alternatively, the identifying the type of the target layer using the decision tree model includes obtaining layer display behavioral characteristic data of the target layer of the target application for a predetermined time period, inputting the layer display behavioral characteristic data into the decision tree model to identify the type of the target layer.

Alternatively, the obtaining the layer display behavioral characteristic data of the target layer of the target application for the predetermined time period includes acquiring the layer display behavioral characteristic data of the target layer at a preset time interval during the predetermined time period, to obtain a plurality of sets of layer display behavioral characteristic data corresponding to the target layer.

Alternatively, the inputting the layer display behavioral characteristic data into the decision tree model to identify the type of the target layer includes inputting each of the plurality of sets of layer display behavioral characteristic data corresponding to the target layer into the decision tree model, respectively, to obtain an identification result corresponding to each of the plurality of sets of layer display behavioral characteristic data, determining the target layer to be the power consumption adjustable layer based on the plurality of identification results corresponding to the plurality of sets of layer display behavior characteristic data all indicating that the target layer is the power consumption adjustable layer.

Alternatively, wherein the layer display behavioral characteristic data includes at least one of a position of the target layer on a Z-axis, a percentage of an area of the target layer to an area of the terminal screen, a transparency of the target layer, whether the target layer corresponds to a specific keyword, whether the target layer belongs to a preset surface view layer type, a content density of the target layer, a horizontal scroll step density of the target layer, a refresh rate value of the target layer, content traffic of the target layer.

Alternatively, layers are pre-classified into a plurality of types based on power consumption, and predetermined at least one of the plurality of types is set to be the power consumption adjustable layer.

Alternatively, the plurality of types includes a first type, a second type and a third type, the first type and the second type are set as the power consumption adjustable layer, wherein the first type is a layer for displaying substantive content of the target application, the second type is a layer for displaying comment information related to the substantive content, the third type is a layer type other than the first type and the second type included in the application.

In accordance with another aspect of the disclosure, an electronic apparatus of running an application is provided. The electronic apparatus includes memory, including one or more storage media, storing instructions, and at least one processor communicatively coupled to the memory, wherein the instructions, when executed by the at least one processor individually or collectively, cause the electronic apparatus to determine a target application for improving power consumption and a target layer of the target application for improving refresh rate, identify a type of the target layer based on a decision tree model, adjust a refresh rate value of the target layer based on the type of the target layer corresponding to a power consumption adjustable layer, determine a refresh rate value of a terminal screen based on the adjusted refresh rate value of the target layer, and run the target application based on the refresh rate value of the terminal screen.

Alternatively, the adjustment module is configured to adjust the refresh rate value of the target layer based on at least one of a center position relationship between the target layer and the terminal screen, an area relationship between the target layer and the terminal screen, and the type of the target layer.

Alternatively, the adjustment module is configured to determine a preset minimum refresh rate value corresponding to the target layer based on at least one of the center position relationship between the target layer and the terminal screen, the area relationship between the target layer and the terminal screen, and the type of the target layer, adjust the refresh rate value of the target layer based on the preset minimum refresh rate value corresponding to the target layer and an actual sampled refresh rate value of the target layer.

Alternatively, the device of running an application further includes a state data acquisition module configured to obtain power consumption and performance state data of the terminal, an optimization module configured to optimize, by a reinforcement learning model, the refresh rate value of the target layer based on the power consumption and the performance state data of the terminal, a second determination module configured to determine an optimized refresh rate value of the terminal screen based on the optimized refresh rate value of the target layer, a second running module configured to run the target application based on the optimized refresh rate value of the terminal screen.

Alternatively, the optimization module is configured to optimize the refresh rate value of the target layer based on the power consumption and the performance state data of the terminal and a preset state action table of the reinforcement learning model, to obtain the optimized refresh rate value of the target layer, wherein the preset state action table includes a plurality of states, each of the states corresponds to a plurality of refresh rate adjusting action types, and each of the refresh rate adjusting action types corresponds to a respective state action penalty value.

Alternatively, the first determination module is configured to determine the refresh rate value of the terminal screen based on the adjusted refresh rate value of the target layer and actual sampled refresh rate value(s) of other layer(s) included in the target application.

Alternatively, the target layer determination module is configured to obtain historical behavioral characteristic data of foreground running of each application installed within the terminal, determine, as the target application, an application whose historical behavioral characteristic data is outside a predetermined range.

Alternatively, the target layer determination module is configured to obtain, while the target application is running, running behavioral characteristic data of the target application, determine, based on the running behavioral characteristic data being outside a preset range, an application layer of the highest actual sampled refresh rate value among a plurality of application layers included in the target application as the target layer.

Alternatively, the identification module is configured to obtain layer display behavioral characteristic data of the target layer of the target application for a predetermined time period, input the layer display behavioral characteristic data into the decision tree model to identify the type of the target layer.

Alternatively, the identification module is configured to acquire the layer display behavioral characteristic data of the target layer at a preset time interval during the predetermined time period, to obtain a plurality of sets of layer display behavioral characteristic data corresponding to the target layer.

Alternatively, the identification module is configured to input each of the plurality of sets of layer display behavioral characteristic data corresponding to the target layer into the decision tree model, respectively, to obtain an identification result corresponding to each of the plurality of sets of layer display behavioral characteristic data, determine the target layer to be the power consumption adjustable layer based on the plurality of identification results corresponding to the plurality of sets of layer display behavior characteristic data all indicating that the target layer is the power consumption adjustable layer.

Alternatively, the layer display behavioral characteristic data includes at least one of a position of the target layer on a Z-axis, a percentage of an area of the target layer to an area of the terminal screen, a transparency of the target layer, whether the target layer corresponds to a specific keyword, whether the target layer belongs to a preset surface view layer type, a content density of the target layer, a horizontal scroll step density of the target layer, a refresh rate value of the target layer, content traffic of the target layer.

Alternatively, layers are pre-classified into a plurality of types based on power consumption, and predetermined at least one of the plurality of types is set to be the power consumption adjustable layer.

Alternatively, the plurality of types includes a first type, a second type and a third type, the first type and the second type are set as the power consumption adjustable layer, wherein the first type is a layer for displaying substantive content of the target application, the second type is a layer for displaying comment information related to the substantive content, the third type is a layer type other than the first type and the second type included in the application.

In accordance with another aspect of the disclosure, one or more non-transitory computer-readable storage media storing one or more computer programs including computer-executable instructions that, when executed by one or more processors of an electronic apparatus individually or collectively, cause the electronic apparatus to perform operations are provided. The operations include determining a target application for improving power consumption and a target layer of the target application for improving refresh rate, identifying a type of the target layer based on a decision tree model, adjusting a refresh rate value of the target layer based on the type of the target layer corresponding to a power consumption adjustable layer, determining a refresh rate value of a terminal screen based on the adjusted refresh rate value of the target layer, and running the target application based on the refresh rate value of the terminal screen.

The technical solutions provided by the embodiments of the disclosure bring at least the following beneficial effects:

The disclosure identifies the type of a target layer whose refresh rate is to be improved by utilizing the decision tree model, and in the case that the type of the target layer belongs to the power consumption adjustable layer, automatically adjust the refresh rate value of the target layer, which is in turn affect the change of the refresh rate value of the terminal screen. In this way, it is realized that the refresh rate of the system is avoided to be forcibly pulled up, and the phenomenon of the working current of the terminal being higher due to the refresh rate of the system being forcibly pulled up and thus causing the power consumption of the terminal to be too large is avoided, and more resources are saved. Moreover, since the disclosure does not require manual setting of the corresponding refresh rate for different APPs one by one, i.e., the whole process does not require manual intervention, it avoids the repetitive and cumbersome setting process and makes the setting of the refresh rate more intelligent and convenient.

Further, the apps are filtered by the historical behavioral characteristic data of foreground running of the apps, which gets the apps that are worth to be optimized. The phenomenon of ineffective optimization for a large number of apps that are not worth to be optimized is avoided, and optimization resources are saved.

Further, since the plurality of sets of collected data are used for identification, the probability of misjudgment is greatly reduced, and the accuracy of identification of the type of the target layer is ensured.

Further, by adjusting the refresh rate value of the target layer through combining multiple dimensions of the characteristics, the accuracy of the adjustment of the refresh rate value is ensured.

Further, by adjusting the refresh rate value of the target layer based on the preset minimum refresh rate value and the actual sampled refresh rate value, the objectivity of adjustment of the refresh rate value is ensured. Moreover, since the determined refresh rate value is a range interval, the phenomenon of directly taking the actual sampled frame rate of the target layer as its final refresh rate value and causing the refresh rate of the system to be forcibly pulled up is avoided, thereby avoiding excessive power consumption of the terminal, and resources are saved.

Further, in determining the refresh rate value of the terminal screen, the adjusted refresh rate value of the target layer and the actual sampled refresh rate values of the other application layers are taken into account, thus it is ensured that the power consumption of the terminal is reduced, and it is ensured that the performance of the terminal is basically unchanged.

Further, since the converged Q-table is obtained after a large amount of training, it is instructive for the actual optimization process of the refresh rate value, and it ensures that the optimized refresh rate value obtained after optimization achieves a better balance between the terminal power consumption and the terminal performance.

Further, since the preset state action table of the reinforcement learning model records the state action penalty value corresponding to each action type of the multiple action types in each of the multiple states, the optimal action that should be performed in the current state is found by simply querying the trained Q-table using the current state of the terminal. Moreover, the optimal refresh rate value that balances the power consumption and performance of the terminal is found by a finite number of queries. Running the target application based on the optimal refresh rate value substantially reduces the power consumption of the terminal, and at the same time, it also ensures that the video playback quality is not affected, i.e., it ensures a smooth viewing experience, and avoid flickering and lagging phenomena on the terminal screen.

Other aspects, advantages, and salient features of the disclosure will become apparent to those skilled in the art from the following detailed description, which taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram illustrating an interface of a video APP that displays barrages while playing a video according to an embodiment of the disclosure;

FIG. 2 is a schematic diagram illustrating an interface of a video APP in which a barrage function is turned off while a video is being played according to an embodiment of the disclosure;

FIG. 3 is a schematic diagram illustrating a barrage layer according to an embodiment of the disclosure;

FIG. 4 is a flowchart illustrating a method of running an application according to an embodiment of the disclosure;

FIG. 5 is a schematic diagram illustrating contents contained in a View Hierarchy of a barrage layer according to an embodiment of the disclosure;

FIG. 6 is a schematic diagram illustrating display data contents in five consecutive frames of a barrage layer according to an embodiment of the disclosure;

FIG. 7 is a schematic diagram illustrating normalization of display contents of a line in a frame of a barrage layer according to an embodiment of the disclosure;

FIG. 8 is a schematic diagram illustrating normalization of display contents of a 64th line in 1st and 2nd frames of a barrage layer according to an embodiment of the disclosure;

FIG. 9 is a graph illustrating an original scatter plot of a horizontal scroll step of a barrage layer according to an embodiment of the disclosure;

FIG. 10 is a graph illustrating a corrected scatter plot of a horizontal scroll step of a barrage layer according to an embodiment of the disclosure;

FIG. 11 is a schematic diagram illustrating characteristic parameters used for different application layers according to an embodiment of the disclosure;

FIG. 12 is a schematic diagram illustrating a training dataset for a decision tree model according to an embodiment of the disclosure;

FIG. 13 is a schematic diagram illustrating a first level root node of a decision tree according to an embodiment of the disclosure;

FIG. 14 is a schematic diagram illustrating some nodes of a first layer and a second layer of a decision tree model according to an embodiment of the disclosure;

FIG. 15 is a schematic diagram illustrating some nodes included in a complete decision tree model according to an embodiment of the disclosure;

FIG. 16 is a schematic diagram illustrating difference in performance scores between a special layer and an ordinary high traffic layer according to an embodiment of the disclosure;

FIG. 17 is a schematic diagram illustrating segmentation of a current and levels of a current factor de according to an embodiment of the disclosure;

FIG. 18 is a schematic diagram illustrating segmentation of a performance score and levels of a performance score factor df according to an embodiment of the disclosure;

FIG. 19 is a schematic diagram illustrating an action type according to an embodiment of the disclosure;

FIG. 20 is a schematic diagram illustrating a table of single-step penalties according to an embodiment of the disclosure;

FIG. 21 is a schematic diagram illustrating a Q-table of initialized states according to an embodiment of the disclosure;

FIG. 22 is a schematic diagram illustrating a Sarsa learning (S, A) state migration according to an embodiment of the disclosure;

FIG. 23 is a schematic diagram illustrating a Sarsa learning Q-table after it has been updated according to an embodiment of the disclosure;

FIG. 24 is a schematic diagram illustrating a Q value in a S(1,1) state according to an embodiment of the disclosure;

FIG. 25 is a block diagram illustrating a device of running an application according to an embodiment of the disclosure; and

FIG. 26 is a block diagram illustrating an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be noted here that “at least one of several items” in the disclosure means including three parallel situations of “any one of the several items”, “a combination of any of the several items”, “the whole of the several items”. For example, “including at least one of A and B” includes the following three parallel situations: (1) including A; (2) including B; (3) including A and B. Another example is “executing at least one of step 1 and step 2”, which means the following three parallel situations: (1) executing step 1; (2) executing step 2; (3) executing step 1 and step 2.

At present, various types of APPs are emerging, and each type of APPS may realize their unique functions. For example, video APPs may be used to play videos, live APPs may be used to broadcast live, game APPs may be used to provide users with game services and so on. In order to enhance a user's interactive experience and create a real-time network environment for multiple users to watch and discuss, the above types of APPs generally have a function of “barrage”. The “barrage” may refer to comment subtitles popping up when watching a video/live broadcast/playing a game on the Internet, and the barrage is generally suspended above the video interface/live broadcast interface/game interface. Further, there are some phenomena, such as the more popular the video/live broadcast is, the greater the number of historical barrages uploaded and distributed by fans is, so that the barrages scroll throughout the video playback; the user's watching habit tends to watch the video content while glancing at the barrages occasionally, so that subtle changes in the display of barrages are not readily noticed; and the function of barrage is more practical, and it may strengthen the cohesion of the fans' watching atmosphere, which in turn enhances the heat. Among them, the disclosure relates to “fans” specifically refers to a group of users who like a certain person or a certain thing.

It should be noted that an APP may contain multiple application layers, and the functions of each application layer are different from each other. Exemplarily, for a video APP, it may contain at least a video layer and a barrage layer, and the barrage layer may be overlaid on top of the video layer.

When a terminal device is running an APP, it generally works in an “adaptive refresh rate mode”, i.e., the refresh rate of the terminal screen is determined by a refresh speed (fps) and an area weight of each of multiple layers contained in the APP. For example, as mentioned above, for the video APP, the refresh speed of its video layer is generally 30 frames per second, while the refresh speed of its barrage layer may reach 120 frames per second, in a case that the area weights of the video layer and the barrage layer satisfy a preset condition, it will be forced to make the refresh rate of the terminal screen, i.e., the refresh rate of the system is maintained at 120 frames per second, but in fact, there is no need for the video to be played at such a high refresh rate. In this case, as the refresh rate of the terminal screen is forced to be high, loads on a Central Processing Unit (CPU)/Graphics Processing Unit (GPU)/Liquid Crystal Display (LCD) used for rendering and synthesis increase, resulting in increased power consumption of the terminal, in turn, this will cause the terminal to heat up, lag, and lose power quickly.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

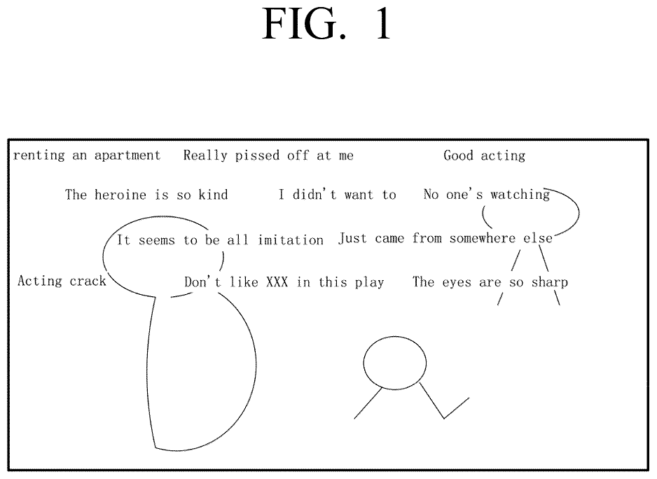

Exemplarily, if a video APP turns on a “barrage” function while playing a video, a working current of the terminal may reach 530 mA, and the display content of the APP while playing the video may be as shown in FIG. 1.

FIG. 1 is a schematic diagram illustrating an interface of a video APP that displays a barrage while playing a video according to an embodiment of the disclosure. At this time, there are four lines of barrages suspending above the playback interface, and these barrages are horizontally scrolling from right to left.

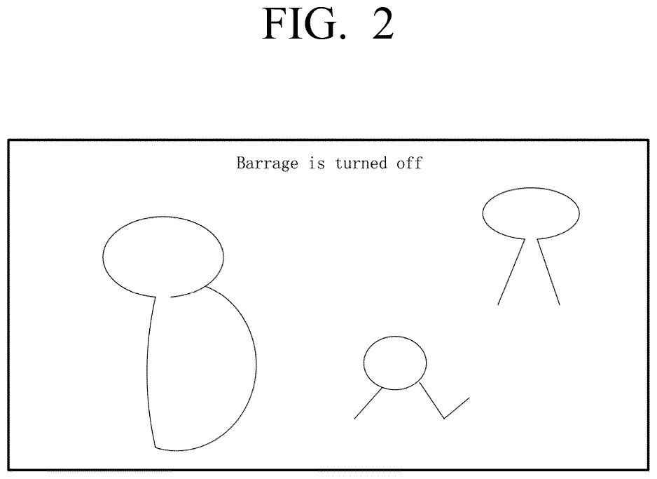

At this time, if the “barrage” function is turned off, the working current of the terminal becomes 326 mA, and the display interface after the “barrage” function is turned off is shown in FIG. 2.

FIG. 2 is a schematic diagram illustrating an interface of a video APP in which a barrage function is turned off while a video is being played according to an embodiment of the disclosure. At this time, only the video content is displayed in the playback interface, and the words “barrage is turned off” are displayed at the top of the playback interface.

As may be seen, the playback interface with the barrage function turned on in FIG. 1 differs from the playback interface with the barrage function turned off in FIG. 2 only in that the video layer is covered with a transparent barrage layer.

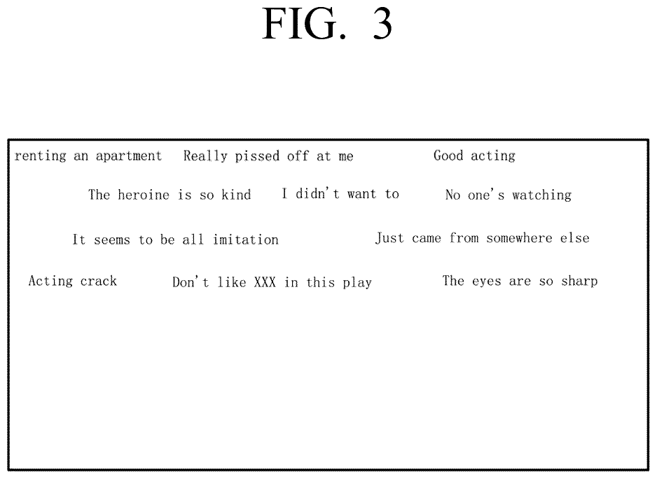

FIG. 3 is a schematic diagram illustrating a barrage layer according to an embodiment of the disclosure.

Referring to FIG. 3, the upper portion of the barrage layer shows four lines of barrage content.

It should be noted that the working current of the terminal is in a positive relationship with the refresh rate value of the terminal screen, i.e., the larger the refresh rate value of the terminal screen is, the higher the working current of the terminal is, and the higher the power consumption of the terminal is. As mentioned above, when the video APP contains both the video layer and the barrage layer, if the barrage layer has the highest refresh speed (fps) and a larger area, and the terminal screen supports such a high refresh rate, then the refresh rate of the system is close to the refresh speed of the barrage layer, i.e., at this time, the final refresh rate of the terminal screen actually depends on the scrolling frame rate of the barrage layer. And, as mentioned above, in the process of the terminal running the video APP, if the barrage function is turned on, its working current is 530 mA; if the barrage function is turned off, its working current is 326 mA. It may be seen that, when the barrage function is turned on, the working current of the terminal would be much higher than when the barrage function is turned off, which has increased by 62.6%, an increase of a very large magnitude. Therefore, the existing “adaptive refresh rate mode” would cause the terminal screen to maintain a high refresh rate level, which leads to unnecessary waste of resources.

In the existing technology, in order to solve the problem of high power consumption caused by turning on the barrage function, the main method is that developers test different APPs and then manually force the refresh rate of each APP to a lower value on a server side, which leads to the following problems:

1. Each user has different demands, i.e., for the same type of APP, different users may have APPs developed by different vendors installed on their terminals, which requires the developers to verify the refresh rate value of each APP one by one and set it on the server side, which is a cumbersome operation process.

2. For a non-playback interface of an APP, such as a menu interface of the APP, manually limiting a lower refresh rate value may lead to lag when the user slides the non-playback interface, i.e., the non-playback interface does not slide smoothly.

3. For a video APP, if the video source itself is a high frame rate video, the APP is forced to playback at a low frame rate may lead to that the advantages of the high frame rate video may not be achieved, the user may not get high quality watching enjoyment.

In order to solve the above problems existing in the related technology, a method of running an app, an apparatus, an electronic device, and a storage medium provided in the disclosure may identify a type of a target layer whose refresh rate is to be improved by utilizing a decision tree model, and in the case that the type of the target layer belongs to a power consumption adjustable layer, may automatically adjust the refresh rate value of the target layer, which may in turn affect the change of the refresh rate value of the terminal screen. In this way, it may be realized that the refresh rate of the system may be avoided to be forcibly pulled up, and the phenomenon of the working current of the terminal being higher due to the refresh rate of the system being forcibly pulled up and thus causing the power consumption of the terminal to be too large may be avoided, and more resources may be saved. Moreover, since the disclosure does not require manual setting of the corresponding refresh rate for different APPs one by one, i.e., the whole process does not require manual intervention; it avoids the repetitive and cumbersome setting process and makes the setting of the refresh rate more intelligent and convenient.

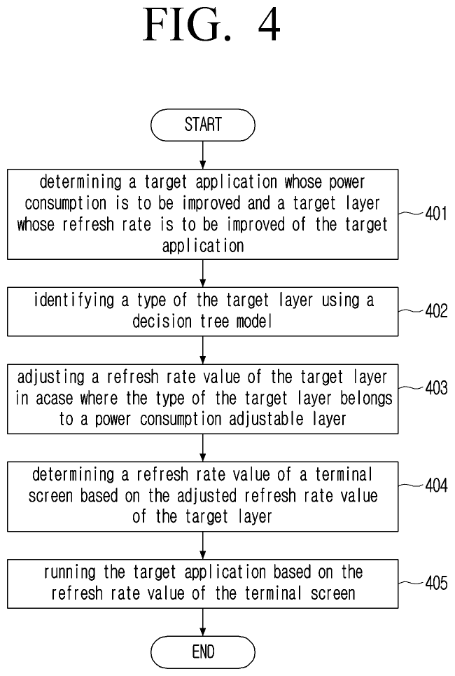

Hereinafter, a method of running an application, a device of running an application, an electronic device and a storage medium according to the disclosure will be described with reference to FIGS. 4 to 26.

FIG. 4 is a flowchart illustrating a method of running an application according to an embodiment of the disclosure.

Referring to FIG. 4, in operation 401, a target application for improving power consumption and a target layer of the target application for improving refresh rate may be determined. Wherein, the target application may include a plurality of application layers, and each application layer is used to implement its specific function. For example, if the target application is a video application, it may contain at least a barrage layer, a video layer, and the like. The barrage layer is mainly used for displaying the barrage, and the video layer is mainly used for displaying the video screen. Moreover, the refresh speeds corresponding to different application layers are generally different from each other. The term “application layer” and the term “layer” may be used interchangeably.

According to an embodiment of the disclosure, historical behavioral characteristic data of foreground running of each application installed in the terminal may be obtained, and then an application whose historical behavioral characteristic data is outside a predetermined range may be identified as the target application.

It should be noted that after the terminal is turned on, a thread may be automatically started, i.e., a system service may be automatically created, which may be used to listen to and collect relevant characteristic data of each app used in the foreground and record them. The above “historical behavioral characteristic data” may contain at least one of historical total running time (FG use time), historical total power consumption (FG app battery drain), historical total power consumed by video-related service module of the app (FG Video battery drain), and historical average running current (FG battery drain) where “FG” means “foreground”.

Further, a monitor may be added to an Activity Manager Service to monitor the switching of the foreground app, and the above “historical behavioral characteristic data” may be obtained by comparing the difference between battery data (batterystats) when the app enters the foreground and when the app exits the foreground. For example, the following command may be executed: Runtime.exec(“adb shell dumpsys batterystats”).

Among them, “batterystats” is a function supported by Android itself, which is based on the principle that device manufacturers need to add “power_profile.xml” to the system, and the “power_profile.xml” may define current standard measurement values for each manufacturer consumed by each hardware component or software module. When the relevant module or process interface is called by the system, the battery data service (batterystats service) may automatically convert a standardized power consumption value based on its use time and other rules. The advantage of this approach is that there is no need to measure all the time in real time, so there is no additional load.

For example, for a certain app, the following data may be sampled and obtained (running in the foreground for 20 minutes):

“When entering the foreground:
UID u0a345: 0.0178 fg: 0.00700 (cpu=0.0107 (394 ms) cpu:fg=0.00700 system_services=0.00706 sensors=0.0000526 (1 s 113 ms))

When exiting the foreground:
UID u0a345: 63.8 fg: 4.91 (screen=48.0 (19 m 36 s 158 ms) cpu=4.66 (8 m 50 s 553 ms) cpu:fg=4.66 (24 s 744 ms) audio=3.65 (19 m 12 s 546 ms) video=7.01 (19 m 20 s 630 ms) system_services=0.198 sensors=0.0555 (19 m 35 s 413 ms) wifi=0.255 (5 s 322 ms) wifi:fg=0.255)”

The power consumption value of the app in the bright screen state may be calculated based on the difference in battery data when the app enters the foreground and when the app exits the foreground. Exemplarily, based on the above sampling results, it may be obtained that the total power consumed by the app up to the time of entering the foreground is 0.0178 mAh, the total power consumed by the app up to the time of exiting the foreground is 63.8 mAh, the total power consumed by the video-related service module up to the time of the app exiting the foreground is 7.01 mAh, and so on.

For example, the following behavioral characteristic data for the app used in the foreground within 20 minutes may be obtained:
Historical total running time=20 min
Historical total power consumption=63.8−0.0178=63.7822 mAh
Historical total power consumed by the video-related services module of the app=7.01−0=7.01 mAh

Since our optimization goal is the app refresh rate, the statistics here is the data when the app is in the foreground and the screen is bright, the power consumption when the app is in the background is not related to the display refresh rate, so it does not need to be considered.

Generally, video playback may involve video module power consumption (“video battery drain”) and audio module power consumption (“audio battery drain”), wherein “video battery drain” means that the app calls video codec/data streaming services, for example, processes, such as media.codec/media.swcodec/media.hwcode/MediaServer may be called during the video playback, which triggers the calculation of their use time and final converts it to standard power. If these media services are not triggered, the power consumed by the video module of the APP is generally 0 or very small (the audio playback generally only consumes power by the audio module), so it may be used to differentiate between ordinary apps and the video app.

For each APP installed in the terminal, a copy of the data as above may be recorded, and the data within each day may be accumulated and processed if it is used in the foreground for many times. Exemplarily, only the use data within the last 7 days may be retained, that is, the user's app use preference and battery consumption behavior data within the last week. Moreover, the data may be used to decide which app is our optimization target when the terminal is in the idle state (Idle) every night. In this way, it may not hinder the normal use of the user, but also filter out the apps that need to be optimized.

The total use time, total power consumption, and total power consumption of the video-related service module of each app for the last 7 days are summarized as follows:

$$app total use time = {\sum }_{k = 0}^{7} app use time$$

$$app total battery drain = {\sum }_{k = 0}^{7} app battery drain$$

$$app total video drain = {\sum }_{k = 0}^{7} app video drain$$

Among them, “app total use time” indicates the total use time of the app within 7 days, “app use time” indicates the use time of the app in one day, “app total battery drain” indicates the total power consumed by the app in 7 days, “app battery drain” indicates the power consumed by the app in one day, “app total video drain” indicates the total power consumed by the video-related service module of the app within 7 days, and “app video drain” indicates the power consumed by the video-related service module of the app within one day.

In addition, generally, for the video app, the average current (app average current) has to be above 300 mA to be worth optimizing. Therefore, the average current of the app needs to be calculated to exclude apps that have been used for a long time and have a low average current despite the total power is not low:

$$app average current = \frac{app total battery drain}{app total use time}$$

A predetermined range is assumed, i.e., the reference thresholds for each parameter are as follows:

An app that is frequently used by the user should meet:

$$T {H}_{app total use time} \geq 5 hour$$

An app that consumes more power should meet:

$$T {H}_{app total battery drain} \geq 1500 mA h$$

An app whose power consumption is worth improving should meet:

$$T {H}_{app average current} \geq 300 mA$$

An app with high power consumption of video-related service module should meet:

$$T {H}_{app total video drain} \geq 36 mA h$$

It should be noted that if the app object to be optimized is not limited to the video category, the condition TH_{app total video drain} may be disregarded. In this way, all apps exceeding the above thresholds may be selected, i.e., APP={a1, a2, a3, . . . aN}, and these selected apps are the high-current video/live streaming/game apps that are worthy of optimization in the subsequent process.

In this way, the apps may be filtered by the historical behavioral characteristic data of foreground running of the apps, which may get the apps that are worth to be optimized. The phenomenon of ineffective optimization for a large number of apps that are not worth to be optimized is avoided, and optimization resources may be saved.

According to an embodiment of the disclosure, during the process in which the target application is running, the running behavior characteristic data of the target application may be obtained. In the case where the running behavior characteristic data exceeds a preset range, an application layer corresponding to the highest actual sampled refresh rate value among the plurality of application layers included in the target application may be determined to be the target layer. Wherein, the “running behavior characteristic data” may include at least one of “a running average current TH_{app average current}”, “a total running power consumed by the video-related service module of the app TH_{app video total drain}”, “a current refresh rate of the terminal screen TH_{system refresh rate}”.

Exemplarily, the running average current (average current) of the target application during playback, the running total power consumed by the video-related service module of the application (video drain), and the current refresh rate value of the terminal screen may be collected at regular intervals, such as every 5 seconds. It is assumed that consecutive collections are performed for about 30 times, it may go to the next step when the values of these three parameters meet the following conditions:

$$T {H}_{app average current} \geq 300 mA$$

$$T {H}_{app video total drain} \geq 3 mA h ( 30 ⋆ 5 seconds )$$

$$T {H}_{system refresh rate} \geq 30 Hz$$

It should be noted that, if the target app to be optimized is not limited to the video app, there is no need to judge whether TH_{app video total drain} meets the preset condition. Moreover, if any one of the above three parameters does not satisfy the preset condition, the detection may be performed again after a time period, such as after a few minutes, until all of the above three parameters satisfy the respective preset condition.

Further, the surface layer characteristic data of the target application during playback may be collected at regular intervals, such as every 5 seconds. The detection in this step is mainly used to confirm the layer distribution of the target application during playback. Take an ordinary scene as an example, generally, if there is a visible Surface View Layer with high traffic, then even if its own refresh rate is not the highest refresh rate, the change of the refresh rates of other layers will greatly affect the change of its power consumption, in which case we call these “other layers” as “Body Surface View Layer”.

Take a video app with a barrage function as an example, generally, the Android app will use one surface view/texture view for real-time video playback, and another surface view/texture view to cover the top of the video or juxtapose for real-time scrolling of barrages. While each surface view/texture view is refreshed through communicating with the display synthesis system (surface flinger) independently, so there will be at least two display layers, i.e., the video layer and the barrage layer, and the refresh speed of each layer, i.e., fps, is only related to its own display content update speed.

When there are two application layers and their respective refresh rates are inconsistent, the refresh rate of the system, i.e., the refresh rate of the terminal screen, is generally the higher one of the two. Therefore, for a low frame rate video, the refresh rate of the video layer is lower and the refresh rate of the barrage layer is higher, and the refresh rate of the system will depend on the refresh rate of the barrage layer, so appropriately lowering the refresh rate of the barrage layer may realize the reduction of the refresh rate of the system, thus achieving the purpose of power saving; for a high frame rate video, the refresh rate of the video layer is higher, and adjusting the refresh rate of the barrage layer individually will not lower the refresh rate of the system, thereby not affecting the experience of high frame rate video playback either.

Further, returning to refer to FIG. 1, a schematic diagram of an interface for displaying a barrage while playing a video is shown in FIG. 1. The data of the plurality of application layers of the video APP illustrated in FIG. 1 may be obtained using “adb shell dumpsys SurfaceFlinger-list|grep com.tencent.qqlive”. Wherein, the locations of the multiple application layers are arranged in a Z-axis up-down relationship or coverage area.

It is assumed that the video APP illustrated in FIG. 1 contains a total of 4 application layers, the acquired data of these 4 application layers may be:

| | |
|---|---|
| “* Layer 0xb40000744e318000 (SurfaceView | // PS: barrage layer |

[com.tencent.qqlive/com.tencent.qqlive.ona.activity.VideoDetailActivity
]@0(BLAST)#606)

| | |
|---|---|
| * Layer 0xb40000744e16b000 (SurfaceView | // PS: video Layer |

[com.tencent.qqlive/com.tencent.qqlive.ona.activity.VideoDetailActivity
]@0(BLAST)#632)

| | |
|---|---|
| * Layer 0xb40000744e0c1000 | //PS: video menu layer |

(com.tencent.qqlive/com.tencent.qqlive.ona.activity.VideoDetailActivity
$_24703#601)

| | |
|---|---|
| * Layer 0xb40000744e2e0000 (Bounds for | //PS: activity main UI |

com.tencent.qqlive/com.tencent.qqlive.ona.activity.VideoDetailActivity@0#604)”

Wherein, the display content of the video layer used to display the content of the video playback is displayed as shown in FIG. 2, and the relevant data of this video layer is shown below:

```
  (Video layer FPS = 24)
  * Layer 0xb40000744e16b000 (SurfaceView
  [com.tencent.qqlive/com.tencent.qqlive.ona.activity.VideoDetailActivity
]@0(BLAST)#632)
```

Wherein, the display content of the barrage layer used to display the content of the barrage scroll is shown in FIG. 3, and the relevant data of the barrage layer is shown below:

```
  (layer FPS = 120)
  * Layer 0xb40000744e318000 (SurfaceView
  [com.tencent.qqlive/com.tencent.qqlive.ona.activity.VideoDetailActivity
]@0(BLAST)#606)
```

Other characteristic parameters of each application layer may also be collected from dumpsys: a position of the application layer on the Z-axis [symbol] Layout Postion (Z direction and X, Y location) [symbol] , an area of the application layer (Layout area), a transparency of the application layer [symbol] Layer Transparency (blend/alpha/isOpaque) [symbol] , and a transparent color of the application layer (Layer Transparent Color), a visibility of the application layer (Layer visibility) and so on.

With the above obtained data of the four application layers, it may determine that there are 2 surface view layers in the current video app playback interface, which are @0(BLAST)#606 and @0(BLAST)#632respectively.

Generally, the video layer is based on the Surface View, and the game layer is also based on the GL_Surface View, and these two Surface View-based application layers are likely to be a High Traffic Layer. If there is another visible higher refresh rate application layer in the app at the same time, then this application layer is also likely to be a High Traffic Layer.

The refresh speed, i.e., the frame rate (fps), of each of the above application layers may also be collected from the display synthesis system. Moreover, the collected frame rate of the application layer is usually a decimal, and the frame rate of the application layer may be rounded up to the refresh rate supported by the terminal screen, and the value of the refresh rate obtained after rounding up may be taken as the corresponding value of the refresh rate of the application layer. Exemplarily, the refresh rate supported by the terminal screen, i.e., the available refresh rate may include seven grades of [10 Hz, 24 Hz, 30 Hz, 48 Hz, 60 Hz, 96 Hz, 120 Hz], and the refresh rate of the terminal screen may only be adjusted and switched within the range of the refresh rate it supports.

Exemplarily, the sampling result for the refresh speeds, i.e., frame rate (fps), of the four application layers included in the video APP illustrated in FIG. 1 may be as follows:

$${fps}_{layer 606} = 101.02 Hz ⇒ Refres {Rate}_{barrage layer} \approx 120 Hz$$

$${fps}_{layer 632} = 23.73 Hz ⇒ Refres {Rate}_{video layer} \approx 24 Hz$$

$${fps}_{layer 601} = 7.12 Hz ⇒ Refres {Rate}_{video menu layer} \approx 10 Hz$$

$${fps}_{layer 604} = 0 Hz ⇒ Refres {Rate}_{layer 604} \approx 0 ( invisible layer , covered )$$

It can be seen, by rounding up the refresh speed, i.e., frame rate, of the application layer, the refresh rates of the above four application layers may be [120 Hz, 24 Hz, 10 Hz, 0 Hz] respectively. Among them, there are two surface view layers in the above four application layers, whose refresh rate values are 120 Hz and 24 Hz respectively; the refresh rate values of the remaining two application layers are 10 Hz and 0 Hz respectively, and there is a big difference in the refresh rate values between different application layers.

As previously mentioned, it may be determined that the application layer corresponding to the highest actual sampled refresh rate value among the multiple application layers contained in the target application is the target layer, and the actual sampled frame rates, i.e., the actual sampled refresh rate values, corresponding to the above four application layers are 101.02 Hz, 23.73 Hz, 7.12 Hz, and 0 Hz, respectively, and, therefore, it may be determined that the barrage layer corresponding to the highest actual sampled refresh rate value among the four application layers is the target layer.

In operation 402, a decision tree model may be used to identify a type of the above target layer.

According to an embodiment of the disclosure, layer display behavioral characteristic data of the target layer of the target application for a predetermined time period may be obtained, and then the layer display behavioral characteristic data may be input into the decision tree model to identify the type of the target layer. Wherein, the decision tree model may be, but is not limited to, a C4.5 decision tree model.

According to an embodiment of the disclosure, the “layer display behavioral characteristic data” may include at least one of a position of the target layer on a Z-axis (Layer Z Position), a percentage of an area of the target layer to an area of the terminal screen (Layer Size), a transparency of the target layer (Layer Transparency), whether the target layer corresponds to a specific keyword (Layer Surface View Keyword), whether the target layer belongs to a preset surface view layer type (Layer Surface View Type), a content density of the target layer (Layer Content Density), a horizontal scroll step density of the target layer (Layer Horizontal Scroll Step Density), a refresh rate value of the target layer (Layer Refresh Rate), content traffic of the target layer (Layer Content Traffic).

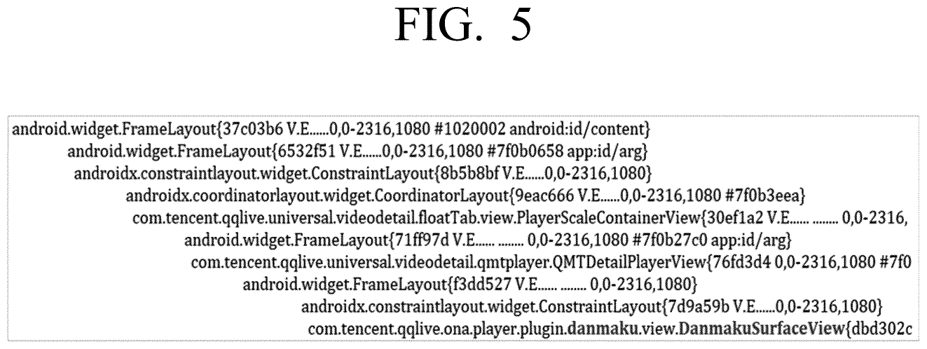

Further, ViewTree information may be first collected by using “adb shell dumpsys activity top”. Wherein, “adb shell dumpsys activity top” may be a function that comes with Android. Taking the above Layer #606 (barrage layer) as an example, contents contained in its View Hierarchy are shown in FIG. 5.

FIG. 5 is a schematic diagram illustrating contents contained in a View Hierarchy of a barrage layer according to an embodiment of the disclosure.

Referring to FIG. 5, the following characteristic parameters of the barrage layer may be collected from the view tree of the barrage layer: whether a specific keyword is contained (Layer Surface View Keyword), a position on the Z-axis (Layout Postion), and an area (Layout area). The reason for collecting the “Layer Surface View Keyword” is that many apps nowadays may integrate and use several open source barrage code library SDKs, and the view names related to the barrage in these SDKs usually contain the following string: “danmake/Danmu/Tanmu/bullet/barrage/ . . . ”, so the characteristic parameter “whether a specific keyword is contained” may be used as a parameter to determine whether an application layer contains a specific keyword. Therefore, the characteristic parameter “whether a specific keyword is contained” may be used as a judgment condition for determining whether a certain application layer is a special layer, i.e., the barrage layer.

Further, display data contents of five consecutive frames of the target layer may be collected. For example, the display data content may be collected by using “adb shell vndservice call display.qservice 21 i32 5 i32 1 i32 1” which comes with Android, or may be directly collected from the display synthesis system.

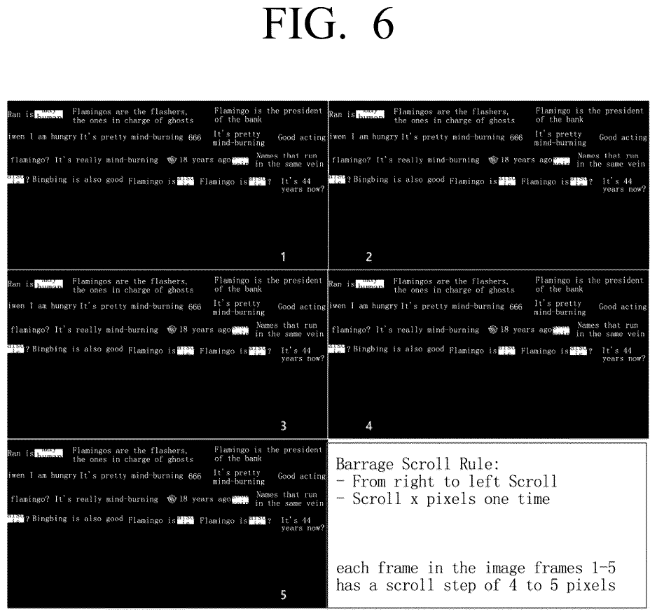

Taking Layer #606 (barrage layer) as an example, layer surface buffer contents of five consecutive frames may be shown in FIG. 6.

FIG. 6 is a schematic diagram illustrating display data contents of five consecutive frames of a barrage layer according to an embodiment of the disclosure.

Referring to FIG. 6, the collected five frames of the barrage layer are labeled as a frame 1, a frame 2, a frame 3, a frame 4, and a frame 5, respectively, and the bottom right corner of FIG. 6 also shows a Barrage Scroll Rule: From right to left Scroll; Each time Scroll x pixels, and the actual scrolling of these five frames: each frame in the frames 1-5 has a scroll step of 4 to 5 pixels (This image frame 1-5 each scroll 4˜5 pixels).

Based on the contents of the layer surface buffer, the following characteristic parameters of the target layer may be calculated: a Layer Content Density, a Layer Horizontal Scroll Step Density, a Layer Content Traffic.

Among them, the content density may be calculated by the following formula:

$$Content Density = \frac{pxiels {count}_{not transparent color}}{pxiels {count}_{all}} ⋆ 100 \%$$

“pxiels count_{not transparent color}” means the number of opaque pixels, “pxiels countₐₗₗ” means the number of all pixels.

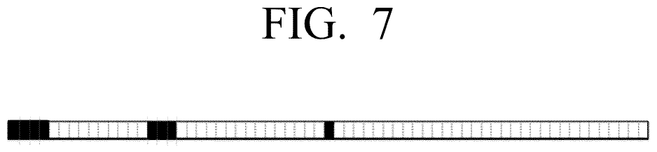

It is assumed that all points of the transparent color are white and all points of the non-transparent color are normalized to black, FIG. 7 is a schematic diagram illustrating normalization of display contents of a line in a frame of a barrage layer according to an embodiment of the disclosure.

Referring to FIG. 7, in this line, pxiels count_{not transparent color}=8, pxiels countₐₗₗ=2316, and here it is assumed that each line of the LCD has 2316 pixels.

Based on the number of all non-transparent pixels contained in all lines of the image frame and the number of all pixels contained in the image frame, the content density of the image frame may be calculated. It is assumed that the calculated content densities of the above five image frames of the barrage layer each are:

$$Content {Density}_{barrage 1 - 5} = \{ 3.607 \% , 3.597 \% , 3.608 \% , 3.579 \% , 3.59 \% \}$$

It should be noted that the frame content density of the video layer is generally 82.8248% (the video layer belongs to an ordinary high traffic layer, and the content density of the ordinary high traffic layer is generally greater than 60%), i.e.:

$$Content {Density}_{video} = 82.8248 \%$$

In general, the content density of the barrage layer is not greater than 20%.

Wherein, the horizontal scroll step density is calculated as follows:

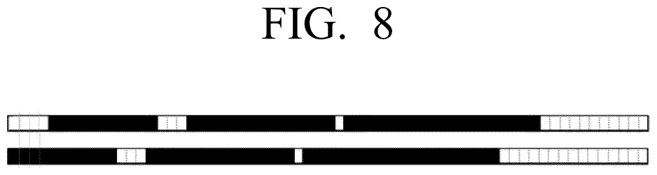

The beginning position of each line that is not transparent color in the 1st frame may be first counted, then the beginning position of each line that is not transparent color in the 2nd frame is counted, and then the difference between the beginning position of each line that is not transparent color is calculated for statistical analysis. Here, it is assumed that all points of transparent color are white and all points of non-transparent color are normalized to black. It is assumed that the non-transparent color exists in a 64th line in both the frame 1 and the frame 2 of the barrage layer, a scatter plot of the 64th line in these two frames is shown in FIG. 8.

FIG. 8 is a schematic diagram illustrating normalization of display contents of a 64th line in frames 1 and 2 of a barrage layer according to an embodiment of the disclosure.

Referring to FIG. 8, the coordinates of a first pixel point in the 64th line in the frame 1 that is not in transparent color may be x=4; and the coordinates of a first pixel point in the 64th line in the frame 2 that is not in transparent color may be x=0. Then the scroll distance of the 64th line between these 2 frames is 0−4=−4. By analogy, the scroll distance of each line in all the lines contained in the image frames may counted.

Within each image frame from the image frame 1 to the image frame 5 of the above barrage layer, there are only 4 lines of text or icons in total, the corresponding actual pixel points have 197 lines, and the rest are transparent colors. The horizontal scroll step distribution of the image frame 2 with respect to the image frame 1 of the barrage layer described above may be counted by collecting these lines together.

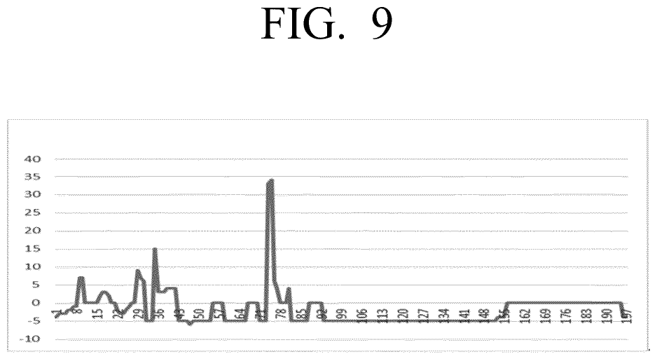

FIG. 9 is a graph illustrating an original scatter plot of a horizontal scroll step of a barrage layer according to an embodiment of the disclosure.

Referring to FIG. 9, a series of numbers in the horizontal direction indicates a serial number of a line contained in the image frame, and a series of numbers in the vertical direction indicates a size of the horizontal scroll step.

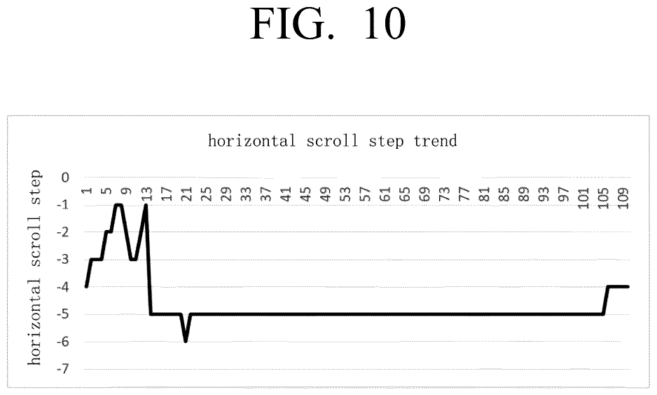

Since the barrages generally scroll from right to left, the step size may only be negative. The case the step size is positive occur when there is a new scroll content or a small amount of background noise in the frame, and it is not really necessary to take into account the part of the frame that has a positive step size. Therefore, all data with the step size being zero or positive integer may be removed, and the horizontal scroll step scatter plot becomes as shown in FIG. 10.

FIG. 10 is a graph illustrating a corrected scatter plot of a horizontal scroll step of a barrage layer according to an embodiment of the disclosure.

Referring to FIG. 10, it may be counted that about 86% of steps fall on “−5”, so the horizontal scroll step of the frame 2 with respect to the frame 1 is −5. Similarly, the horizontal scroll step between other frames may be obtained as well as the density. For example, the horizontal scroll step of the frame 3 with respect to the frame 2 is −4, and the density is 87%; the horizontal scroll step of the frame 4 with respect to the frame 3 is −5, and the density is 88%; the horizontal scroll step of the frame 5 with respect to the frame 4 is −4, and the density is 85%. It should be noted that if the probability of having 2 adjacent steps between certain 2 frames is approximate, for example, 40% of steps fall on −4 and 45% of steps fall on −5, then it may be assumed that 85% of steps between these 2 frames fall on −4.5.

In this way, the horizontal scroll step for the 5 image frames 1 to 5 collected from the barrage layer this time is:

$$Horizontal Scroll Step = \frac{{\sum }_{1}^{5} horizontal scroll step}{4} = \frac{( - 5 ) + ( - 4 ) + ( - 5 ) + ( - 4 )}{4} = - 4.5$$

The horizontal scroll step density is:

$$Horizontal Scroll Step Density = \frac{{\sum }_{1}^{5} horizontal scroll step Density}{4} ⋆ 100 \% = \frac{0.86 + 0.87 + 0.88 + 0.85}{4} = 8 6.5 \%$$

The above process of calculating the horizontal scroll step and the horizontal scroll step density only needs to traverse the pixel points once for accumulating and counting, which is very simple and fast and does not require complex image recognition process. Generally, the horizontal scroll step density of the barrage layer is more than 65%, while the horizontal scroll step density of the non-barrage layer is generally very small.

It should be noted that the barrages may scroll vertically in addition to horizontally from right to left. For example, it may also scroll vertically from bottom to top. At this point, when calculating the vertical scroll step and vertical scroll step density, it just needs to change to calculate the vertical scroll step by column, the principle is the same as the horizontal scroll step, which will not be repeated here.

Wherein, the content traffic may be calculated by the following methods:

For five image frames 1˜5 sampled from the barrage layer, MD5 fast operation may be performed on all data in each frame in turn, and then a 64-bit md5 value may be obtained:

$$md 5 ( i ) = {\sum }_{n = 0}^{all pixel} MD 5 ( each pixel )$$

Then, an md5 repeatability of these five frames may be calculated. The repeatability is calculated by sorting the five md5 values, then checking how many different values there are, and finally dividing the number of different values by the total number of frames to get the content traffic, i.e.:

$$content traffic = ( ( Num of different Md 5 ) / 5 ⋆ 100 \%$$

Generally, the higher the content traffic is, the greater the difference between the power consumption in different refresh rates of the application layer will be, that is, the impact on power consumption will be relatively obvious. An ordinary high traffic layer has a content traffic greater than 60%.

Further, the content density of Body SurfaceView Layer may be calculated as follows:

If there are Surface View Layers in addition to the highest refresh rate layer, then the content density of all Surface View Layers may be calculated and the maximum value may be taken:

$$Max body SurfaceView Content Density = Max {max}_{0 \leq surfaceview layer \leq N} layer content density$$

The content traffic of Body Surface View Layer may be calculated as follows:

If there are Surface View Layers in addition to the highest refresh rate layer, then the content traffic of all Surface View Layers is calculated and the maximum value is taken:

$$Max body SurfaceView Content Traffic = Max {max}_{0 \leq surfaceview layer \leq N} layer content traffic$$

It should be noted that if the target layer, i.e., the highest refresh rate layer, is not the surface view layer, then “Max body Surface View Content Density” and “Max body Surface View Content Traffic” are also inputted into the subsequent decision tree model as one of the influencing factors for identifying the type of target layer; if the target layer, i.e., the layer with the highest refresh rate, is the surface view layer, “Max body Surface View Content Density” and “Max body Surface View Content Traffic” will not be input into the subsequent decision tree model, i.e., at this time, these two parameters will not be used as influencing factors for identifying the type of the target layer.

According to an embodiment of the disclosure, an application layer may be pre-classified into a plurality of types according to power consumption, and predetermined at least one of the plurality of types may be set as a power consumption adjustable layer.

Wherein, the decision tree model may be, but is not limited to, a C4.5 decision tree model.

According to an embodiment of the disclosure, an application layer may be pre-classified into a plurality of types based on power consumption, such as, but not limited to, a high power consumption layer (which may also be referred to as a high process volume) and a low power consumption layer (which may also be referred to as a low process volume). Additionally, the high power consumption layer and the low power consumption layer may be further classified based on the content of the display, e.g., the high power consumption layer may be classified as, but is not limited to, a content layer and a comment information layer. By way of example, the high power consumption layer may be classified into a first type and a second type, i.e., the first type may be an application layer for displaying substantial content of the target application, which may also be referred to as a general high traffic layer. Exemplarily, this may be a Video Layer/Game Layer; the second type may be an application layer for displaying comment information related to the substantive content, exemplarily, this may be a barrage layer. Both types may be set as the power consumption adjustable layers due to high current consumption. In addition, the low power consumption layer may be a third type, which may also be called a general low traffic layer, and usually the current consumption due to this type is relatively low, and thus may not be set as the power consumption adjustable layer. Of course, the classification of the application layer is not limited to the above example, but may also be made based on the actual power consumption or functional state, and the foregoing classification is merely an illustration.

When identify the type of the application layer by using the decision tree model, the characteristic parameters used for different application layers may be different.

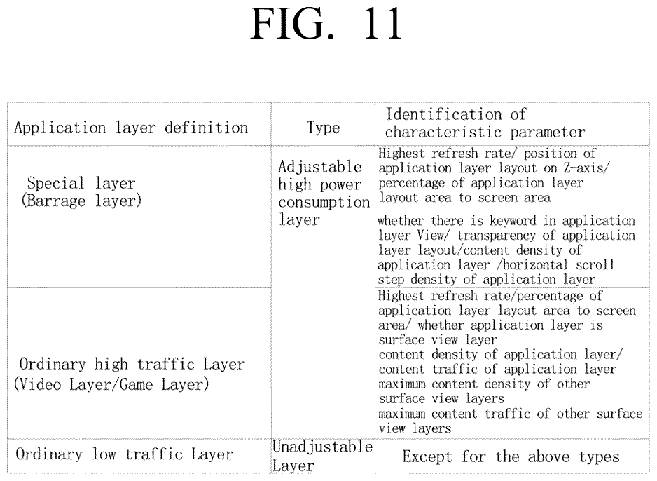

FIG. 11 is a schematic diagram illustrating characteristic parameters used for different application layers according to an embodiment of the disclosure.

Referring to FIG. 11, although both a Special Layer and an ordinary high traffic layer belong to the adjustable high power consumption layer, the characteristic parameters for identifying correspond to them are different, and there may be partially overlapping among them; the Ordinary Low traffic Layer is an Unadjustable Layer, and its corresponding identification rule may be as follows: if it is recognized that a certain application layer is not one of the above two types of the Special Layer and the ordinary high traffic layer, then it belongs to the Ordinary Low Traffic Layer.

First, a decision tree model needs to be established first. A training dataset for the decision tree model may be formed by performing automated testing on hundreds of known samples and sampling characteristic data.

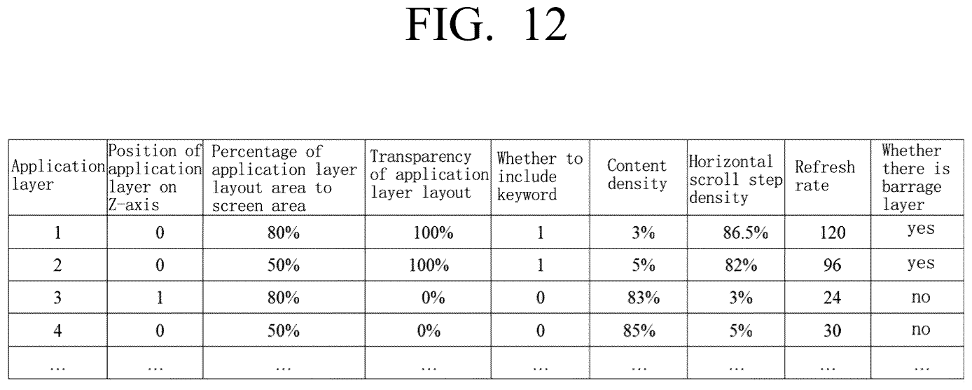

FIG. 12 is a schematic diagram illustrating a training dataset for a decision tree model according to an embodiment of the disclosure.

Referring to FIG. 12, each application layer may correspond to a plurality of features including, but not limited to: a position of a layer layout on the Z-axis (Layer Z Position), a percentage of an area of the application layer layout to the screen area (Layer Size), a transparency of the application layer layout (Layer Transparency), whether a keyword is included (Layer Surface View Keyword), whether it is a surface view layer (Layer Surface View Type), a content density (Layer Content Density), the maximum content density of other surface view layers (Max body Surface View Layer Content Density), a horizontal scroll step density (Layer Horizontal Scroll Step Density), a refresh rate of the application layer (Layer Refresh Rate), content traffic (Layer Content Traffic), the maximum content traffic of other surface view layers (Max Body Surface View Layer Content Traffic).

Among them, “Layer Z Position” may indicate the position of the layer layout on the Z-axis, which may be classified into three levels: 0, 1, 2, of which, “0” may be indicated at the top, “1” may be one level below “0”, and “2” may be one level below “1”. Generally, the “Layer Z Position” of the barrage layer is the smallest, that is, the position of the barrage layer is generally at the top layer.

“Layer Size” may indicate the percentage of the area of the application layer layout to the screen area, it may be classified into three levels: <28%, 28˜72%, >72%. Generally, the “Layer Size” of the barrage layer is larger.

“Layer size”=(layer width*layer height)/(screen width*screen height)*100%, where, “layer width” represents the width of the application layer, “layer height” represents the height of the application layer, “screen width” represents the width of the terminal screen, “screen height” represents the height of the terminal screen.

“Layer Transparency” may indicate the transparency of the application layer layout, which may be classified into five levels: 0%, <50%, 50˜70%, 70˜99%, 100%. Among them, 0% may indicate completely opaque, 100% may indicate completely transparent. Generally, the “Layer Transparency” of the barrage layer is the largest.

“Layer Surface View Keyword” may indicate whether the layer view contains keyword(s), such as danmake/Danmu/Tanmu/bullet/barrage. In this case, 0 means no; 1 means yes.

“Layer Surface View Type” may indicate whether the corresponding application layer is the Surface View Layer, where 0 may indicate no and 1 may indicate yes. Generally, the probability that the surface view layer is the ordinary high traffic layer is higher.

“Layer Content Density” is the content density, which may be classified into five levels: <10%, 10˜25%, 25˜50%, 50%˜75%, >75%. Generally, the content density of the barrage layer is small, while the content density of the ordinary high traffic layer is large.

“Max body Surface View Layer Content Density” may be classified into five levels in a manner similar to “Layer Content Density”.

“Layer Horizontal Scroll Step Density” is the horizontal scroll step density, it may be classified into five levels: <10%, 10˜25%, 25˜50%, 50˜70%, >70%. Generally, the “Layer Horizontal Scroll Step Density” of the barrage layer is larger.

“Layer Refresh Rate” is the refresh rate of the application layer, it may be classified into five levels: <=24, 30, 48, 60, >=96. Generally, the “layer refresh rate” of the barrage layer is larger.

“Layer Content Traffic” is the content traffic, which may be classified into five levels: <10%, 10˜25%, 25˜50%, 50˜70%, >70%. Generally, the ordinary high traffic layer's “Layer Content Traffic” is larger.

The “Max Body Surface View Layer Content Traffic” may be classified into five levels in a manner similar to the “Layer Content Traffic”.

In the disclosure, a C4.5 entropy gain rate may be used to decide the effect of each factor on the final decision result. It is assumed that the total number of samples (cases) is 300. Wherein, the number of samples with a barrage layer (has barrage) is 100 and the number of samples without a barrage layer (no barrage) is 200. “has barrage” may be called a positive example and “no barrage” may be called a negative example.

First, the information entropy formula may be shown as follows:

$$Entropy ( S ) = Entropy ( p 1 , p 2 , … pn ) = - {\sum }_{i = 1}^{n} ( p i * {log}_{2} p i )$$

The total entropy value of the very first root node may be calculated based on the above information entropy formula:

$$E n t ( S ) = E ( \frac{100}{300} , \frac{200}{300} ) = - \frac{100}{300} {log}_{2} \frac{100}{300} - \frac{200}{300} {log}_{2} \frac{200}{300} = e 1$$

Then, the entropy gain of each feature, such as “the position of the layer layout on Z-axis”, “the percentage of the area of the application layer layout to the screen area”, “the transparency of the application layer layout” may be calculated.

Exemplarily, the entropy gain of “the position of the layer layout on the Z-axis” may be calculated first. It is assumed that there are 150 samples with feature value “0”, 80 samples with feature value “1”, and 80 samples with feature value “2”, the entropy gain in the “Layer layout position on Z-axis”. Then it is assumed that there are 90 positive cases and 60 negative cases in the samples with feature value “0”, 30 positive cases and 50 negative cases in the samples with feature value “1”, and 5 positive cases and 65 negative cases in the samples with feature value “2”.

The entropy value of the attribute “Layer Z Position”=0 is:

$$E n t ( D 11 ) = - \frac{90}{150} {log}_{2} \frac{90}{150} - \frac{60}{150} {log}_{2} \frac{60}{150} = d 11$$

The entropy value of the attribute “Layer Z Position”=1 is:

$$E n t ( D 12 ) = - \frac{30}{80} {log}_{2} \frac{30}{80} - \frac{50}{80} {log}_{2} \frac{50}{80} = d 12$$

The entropy value of the attribute “Layer Z Position”=2 is:

$$E n t ( D 13 ) = - \frac{5}{70} {log}_{2} \frac{5}{70} - \frac{65}{70} {log}_{2} \frac{65}{70} = d 13$$

Then the entropy gain of the attribute “Layer Z Position” is:

$$Gain ( D 1 ) = e 1 - d 11 * \frac{150}{300} - d 12 * \frac{80}{300} - d 13 * \frac{70}{300} = g 1$$

Similarly, the entropy gain of the other attributes may be calculated as:
Layer Size=g2; Layer Transparency=g3;
Layer Surface View Keyword=g4; Layer Content Density=g5;
Layer Horizontal Scroll Step Density=g6; Layer FPS=g7.

Theoretically, the attribute with the largest entropy gain may be used as the first level root node of the decision tree and then other attributes are subdivided downwards. However, since the entropy gain actually has a preference for attributes with a higher number of values that may be taken, i.e., the more samples it has, the larger the possible entropy gain value is. Therefore, the entropy gain rate may be used to select the first level root node as follows:

First, the average entropy gain value of all attributes is calculated:

$$Gain ( average ) = \frac{g 1 + g 2 + g 3 + g 4 + g 5 + g 6 + g 7}{7} = g 0$$

Then, the corresponding attribute whose entropy gain is greater than the average entropy gain value is found out from all the attributes. It is assumed that the entropy gain (g1) of Layer Z Position and the entropy gain (g5) of Layer Content Density are greater than the average entropy gain value g0.

Next, the entropy gain rate of “Layer Layout Position on Z Axis” may be calculated:

First, the intrinsic value IV (D1) of the “Layer layout position on Z-axis” may be calculated. Since there are 150 samples with feature value 0, 80 samples with feature value 1, and 70 samples with feature value 2 in the “Layer Layout on Z-axis”,

$$IV ( D 1 ) = - \frac{150}{300} {log}_{2} \frac{150}{300} - \frac{80}{300} {log}_{2} \frac{80}{300} - \frac{70}{300} {log}_{2} \frac{70}{300} = i 1$$

Then, the entropy gain rate of “Layer layout on Z-axis” may be calculated:

$$GainR ( D 1 ) = \frac{g 1}{i 1} = r 1$$

Similarly, the entropy gain rate of “content density” may be calculated: r2.

Next, the attribute with the larger entropy gain rate may be selected as the root node of the first layer of the decision tree. If r1=r2, then either one of “Layer layout position on the Z-axis” and “Content density” may be selected as the root node of the first level.

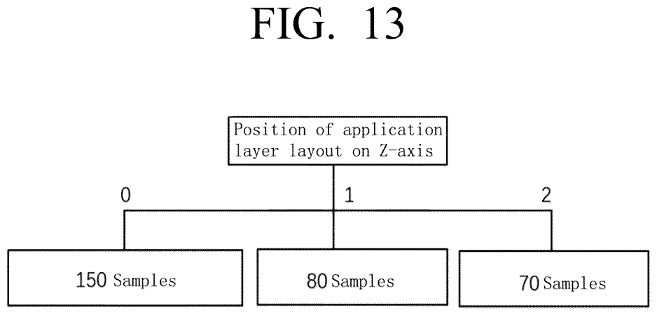

FIG. 13 is a schematic diagram illustrating a first level root node of a decision tree according to an embodiment of the disclosure.

Referring to FIG. 13, “Layer layout position on Z-axis” is the first level root node of the decision tree model, which contains a total of three branches, namely, a branch with feature value equal to 0, a branch with feature value equal to 1, and a branch with feature value equal to 2.

After obtaining the root node of the first layer (the position of the Layer layout on the Z-axis), the branch root node of the second layer may be selected. Referring back to FIG. 13, there are 3 branches in total. Refer to the first branch, i.e., the branch with feature value equal to 0. In this branch, the number of samples in the sample set is 150, of which 90 are positive cases and 60 are negative cases. Therefore, the total entropy value of the branch root node under this branch may be calculated:

$$E n t ( S ) = E ( \frac{90}{150} , \frac{60}{150} ) = - \frac{90}{150} {log}_{2} \frac{90}{150} - \frac{60}{150} {log}_{2} \frac{60}{150} = e 21$$

Similarly, the entropy gains of the following attributes may be calculated:
Layer Size=g21; Layer Transparency=g22;
Layer Surface View Keyword=g23; Layer Content Density=g24;
Layer Horizontal Scroll Step Density=g25; Layer FPS=g26

It should be noted that there is no need to calculate the entropy gain of “Layer Layout Position on Z Axis” again.

Similarly, the average entropy gain of all attributes of the layer may be calculated:

$$Gain ( average ) = \frac{g 21 + g 22 + g 23 + g 24 + g 25 + g 26}{6} = g 20$$

Similarly, the attributes that are greater than the average entropy gain value g20 may be found out from all the attributes of the layer. It is assumed that the entropy gain (g22) of Layer Transparency, the entropy gain Layer (g24) of Content Density, and the entropy gain (g25) of Layer Horizontal Scroll Step Density are greater than the average entropy gain value g20. Similarly, the attribute with the largest entropy gain among these three attributes may be found out. It is assumed that that the attribute with the largest entropy gain is “Content Density”, it may be selected as the branch root node of this branch.

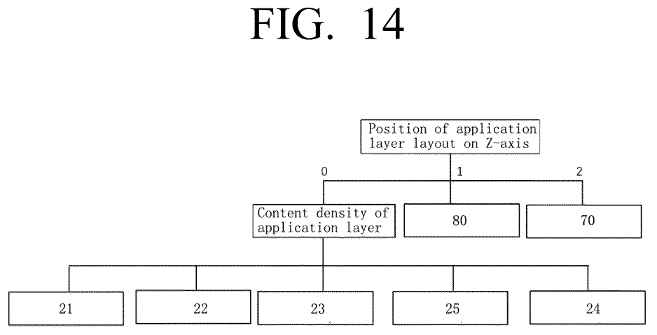

FIG. 14 is a schematic diagram illustrating some nodes of a first layer and a second layer of a decision tree model according to an embodiment of the disclosure.

Referring to FIG. 14, “Content Density” is selected as a branch root node of the second layer of the decision tree, and five branches are subdivided under this branch root node.

By analogy, a complete decision tree model may be established based on the training data set by following the similar calculation method.

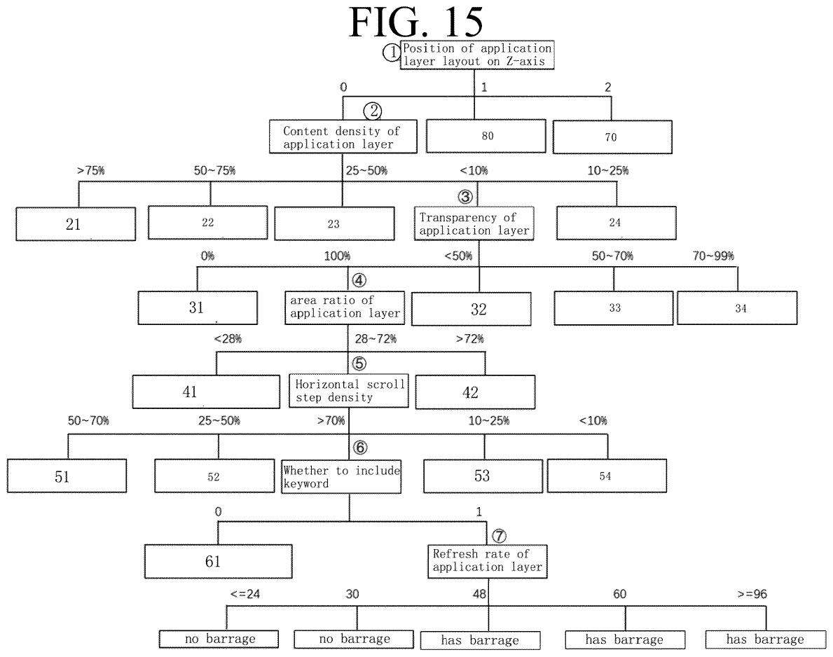

FIG. 15 is a schematic diagram illustrating some nodes included in a complete decision tree model according to an embodiment of the disclosure.

Referring to FIG. 15, at each layer of the decision tree, only one branch is selected to be expanded downward, and in fact, each branch of each layer of the decision tree model may be expanded downward with more branches, i.e., the decision tree model is actually a relatively large structure.

In order to avoid redundancy, FIG. 15 shows only some nodes in the decision tree model. Moreover, after expanding using all attributes, each of the multiple branches contained in the root node of the last branch will point to its respective category, i.e., either “has barrage” or “no barrage”.

In this way, the layer display behavioral characteristic data of the target layer may be used to filter the decision tree model step by step. When the filtering reaches the bottom level of the decision tree model, the category corresponding to the branch into which the layer display behavioral characteristic data of the target layer ultimately falls is the type of the target layer, i.e., either “has barrage” or “no barrage”.

According to an embodiment of the disclosure, the layer display behavioral characteristic data of the target layer may be collected at predetermined intervals during a predetermined time period to obtain a plurality of sets of layer display behavioral characteristic data corresponding to the target layer. Exemplarily, the layer display behavioral characteristic data of the target layer may be collected every 5 seconds for 30 consecutive times, and a total of 30 sets of layer display behavioral characteristic data may be obtained.

According to an embodiment of the disclosure, each of the plurality of sets of layer display behavioral characteristic data corresponding to the target layer may be input into the decision tree model, respectively, to obtain identification result corresponding to each set of layer display behavioral characteristic data. Exemplarily, the 30 sets of layer display behavioral characteristic data may be input into the decision tree model, respectively, to obtain the identification result corresponding to each set of layer display behavioral characteristic data.

Next, in the case where the plurality of sets of identification results corresponding to the plurality of sets of layer display behavioral characteristic data all indicate that the target layer is a power consumption adjustable layer, the target layer may be determined to be the power consumption adjustable layer. Exemplarily, in the case where the 30 sets of identification results corresponding to the 30 sets of layers displaying the behavioral characteristic data all indicate that the target layer is the power consumption adjustable layer, it may be determined that the target layer is the power consumption adjustable layer.

It is noted that if only one set of layer display behavioral characteristic data is used to identify the type of the target layer, the phenomenon of misjudgment may occur. Therefore, the disclosure may collect a plurality of sets of layer display behavioral characteristic data and determine the type of the target layer as a same type only when the plurality of sets of identification results corresponding to the plurality of sets of layer display behavioral characteristic data all indicate that the type of the target layer is the same type. In this way, since the plurality of sets of collected data are used for identification, the probability of misjudgment may be greatly reduced, and the accuracy of identification of the type of the target layer may be ensured.

In operation 403, in the case where the type of the target layer belongs to the power consumption adjustable layer, the refresh rate value of the target layer may be adjusted. For example, in the case where the type of the target layer belongs to an adjustable high power consumption layer (special layer, ordinary high traffic layer), the refresh rate value of the target layer may be adjusted.

It should be noted that, in the existing technology, when the terminal is in the adaptive refresh rate mode, the refresh rate of the system is voted by the current refresh speed and the area ratio of each layer, the basic principle is shown in the following formula:

$${Layer}_{weight} = \frac{Layer area}{Screen area} * 100 \% \geq T {H}_{layer}$$

$$Refresh {Rate}_{system} = {max}_{All Layer weight \geq TH} Layer FPS {⋃}_{i d = 0}^{n} \{ LCD Display Models \}$$

Where, “Layer weight” denotes the area ratio of the application layer, i.e., area weight, “Layer area” denotes the area of the application layer, “Screen area” denotes the area of the terminal screen, “TH_{layer}” denotes the area ratio threshold, “Refresh Rate_{system}” denotes the refresh rate of the System, “Layer FPS” denotes the refresh rate of the application layer, “LCD Display Models” denotes the refresh rate supported by the liquid crystal display.

The first formula means that if the total refresh rate of the system is to be affected, then the area weight of the application layer must exceed the threshold; the second formula means that the final refresh rate of the system depends on the highest refresh rate of all application layers that meet the area ratio threshold, and this refresh rate must also belong to the range of the refresh rate supported by the liquid crystal display. Exemplarily, the screen of a certain terminal supports seven refresh rates of [10 Hz, 24 Hz, 30 Hz, 48 Hz, 60 Hz, 96 Hz, 120 Hz].

As mentioned before, the refresh rate values of the four application layers included in the video APP shown in FIG. 1 are [120 Hz, 24 Hz, 10 Hz, 0 Hz], in which the application layer with the largest refresh rate is the barrage layer, and its refresh rate is 120 Hz. If the refresh rate value of the barrage layer's participation in the voting is not interfered, then the refresh rate of the system takes the value of:

$$Refresh {Rate}_{system before} = {max}_{All Layer weight \geq TH} \{ 1 \; 20 , 24 , 10 \} = 120 Hz$$

It may be seen that at this time, the refresh rate of the system is forced to be pulled up to a high refresh rate, which will lead to excessive power consumption of the terminal, resulting in a waste of resources.

Therefore, according to an embodiment of the disclosure, the refresh rate value of the target layer may be adjusted based on at least one of a center position relationship between the target layer and the terminal screen, an area relationship between the target layer and the terminal screen, and the type of the target layer.

It should be noted that, from the visual experience, it may be considered that the closer the center position of the application layer is to the center position of the screen, the higher its refresh rate may be; or, the larger the ratio of the area of the application layer to the area of the terminal screen, i.e., the larger the area of the application layer accounts for, the higher the refresh rate of the application layer may be; or, the type of the application layer is different, and so is its refresh rate. For example, the refresh rate of the barrage layer is generally higher than that of the video layer and so on. In this way, by adjusting the refresh rate value of the target layer through combining the multiple dimensions of characteristics, the accuracy of the adjustment of the refresh rate value may be ensured.

According to an embodiment of the disclosure, a predetermined minimum refresh rate value corresponding to the target layer may be determined based on at least one of a center position relationship between the target layer and the terminal screen, an area relationship between the target layer and the terminal screen, and the type of the target layer.

Exemplarily, Take the center position relationship between the target layer and the terminal screen as an example, the following correspondence may be set:
If a distance between the center position of the application layer (Layer center position) and the center position of the screen center (Screen center) is not more than ⅓ of the height of the application layer, the minimum refresh rate of the application layer may be set to 48 Hz;
If the distance between the center position of the application layer and the center position of the screen center is more than ⅓ of the height of the application layer, the minimum refresh rate of the application layer may be set to 30 Hz.

Then, the refresh rate value of the target layer may be adjusted based on the preset minimum refresh rate value corresponding to the target layer and the actual sampled refresh rate value of the target layer. As previously described, among the four application layers included in the video APP shown in FIG. 1, the target layer is the barrage layer, and its actual sampled frame rate is 101.02 Hz, i.e., its actual sampled refresh rate value is 101.02 Hz, and the refresh rate value supported by the terminal screen obtained by upwardly rounding the actual sampled frame rate is 120 Hz. It is assumed that the distance between the center position of the application layer and the center position of the screen center is less than ⅓ of the height of the application layer, the preset minimum refresh rate of the target layer may be 48 Hz. At this time, the refresh rate of the target layer may be determined to be in the range of [48 Hz, 60 Hz, 96 Hz, 120 Hz].

In this way, by adjusting the refresh rate value of the target layer based on the preset minimum refresh rate value and the actual sampled refresh rate value, the objectivity of adjustment of the refresh rate value may be ensured. Moreover, since the determined refresh rate value is a range interval, the phenomenon of directly taking the actual sampled frame rate of the target layer as its final refresh rate value and causing the refresh rate of the system to be forcibly pulled up may be avoided, thereby avoiding excessive power consumption of the terminal, and resources may be saved.

In operation 404, a refresh rate value of the terminal screen may be determined based on the adjusted refresh rate value of the target layer.

According to an embodiment of the disclosure, the refresh rate value of the terminal screen may be determined based on the adjusted refresh rate value of the target layer and the actual sampled refresh rate values of other application layers included in the target application.

Exemplarily, the left endpoint of 48 Hz in the range of refresh rate values [48 Hz, 60 Hz, 96 Hz, 120 Hz] of the target layer may be taken as the refresh rate value for the target layer to participate in the voting, i.e., the display synthesis system may be notified that the refresh rate value of the target layer is specified as 48 Hz. At this time, since the refresh rate values of the three application layers whose area ratio satisfies the threshold value among the four application layers included in the video app illustrated in the FIG. 1 are [48 Hz, 24 Hz, 10 Hz], the display synthesis system will automatically change the final refresh rate of the current system to 48 Hz when it calculates the overall refresh rate of the system:

$$Refresh {Rate}_{s ystem after} = {max}_{All Layer weight \geq TH} \{ 48 , 24 , 10 \} = 48 Hz$$

As may be seen, in the disclosure, it is not actually necessary to adjust the adjustable high power consumption layer itself, but only need to tell the display synthesis system what the refresh rate of this application layer is, which will directly affect the final system refresh rate calculated by the display synthesis system. Moreover, in determining the refresh rate value of the terminal screen, the adjusted refresh rate value of the target layer and the actual sampled refresh rate values of the other application layers are taken into account, i.e., it may be ensured that the power consumption of the terminal may be reduced, and it may be ensured that the performance of the terminal is basically unchanged.

In operation 405, the target application may be run based on the refresh rate value of the terminal screen.

It should be noted that when the refresh rate of the adjustable high power consumption layer is adjusted downward, the power consumption of the terminal decreases because of the decrease in the refresh rate, but the decrease in the refresh rate also causes the performance of the application layer to change. How to balance the gains in power consumption and performance and determine the most appropriate refresh rate is another issue that needs to be addressed.

After adjusting the refresh rate for two different adjustable high power consumption layers in the disclosure, there are some differences in the evaluation of their improved performance, even though both of them end up with a decrease in the working current as a result of the improvement.

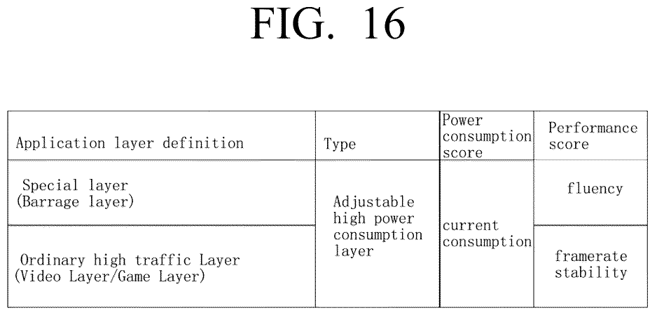

FIG. 16 is a schematic diagram illustrating difference in performance scores between a special layer and an ordinary high traffic layer according to an embodiment of the disclosure.

Referring to FIG. 16, for the special layer, the special layer may be evaluated in terms of fluency, and for the ordinary high traffic layer, the ordinary high traffic layer may be evaluated in terms of layer framerate stability.

Here, the special layer (barrage layer) is taken as an example first to illustrate calculation of a performance score. Among them, the “fluency of barrage scrolling” (Layer Fluency) refers to whether or not the scrolling process will occur flicker, i.e., scroll flicker. The “fluency of barrage scrolling” is mainly measured and evaluated from two characteristics, which actually determine the display quality of the barrage:
a horizontal scroll step (Layer Horizontal Scroll Step)
a horizontal scroll step per second (Layer Horizontal Scroll Distance)

Wherein, the calculation process of the horizontal scroll step is specifically referred to the relevant description in operation 402 and will not be repeated here. Moreover, the absolute value of the horizontal scroll step may be taken. For example, it is assumed that the horizontal scroll distance is −4, the absolute value is: |−4|=4.

The “horizontal scroll distance per second” may be calculated using the following formula:

$$scroll distance = \vert scroll step * refresh rate \vert$$

It may be seen that if the horizontal scroll step is too small, although the scrolling is very smooth, the lower refresh rate will lead to the horizontal scroll distance per second is too short or scroll too slow; if the horizontal scroll step is too large, the scrolling is not very smooth, and the higher refresh rate will lead to the horizontal scroll distance per second is too long or scroll too fast. After many tests, the better barrage scrolling experience is: the horizontal scroll step is between 3˜6; the horizontal scroll distance per second is around 180, that is, if the refresh rate is too big, the scrolling is faster, if the refresh rate is too small, the scrolling is slower.

From this, a score for the smoothness of the barrage may be defines (with values from 0 to 1).

$$If the horizontal scroll step = 3 ∼ 6 , score = ( 1 - a * \frac{\vert scroll distance - 180 \vert}{180} ) * 1.0$$

$$If the horizontal scroll step < 3 , score = ( 1 - a * \frac{\vert scroll distance - 180 \vert}{180} ) * ( 1. - b * \frac{3 - scroll step}{0.5} )$$

$$If the horizontal scroll step > 6 , score = ( 1 - a * \frac{\vert scroll distance - 180 \vert}{180} ) * ( 1. - b * \frac{scroll step - 6}{0.5} )$$

Where a=0.5, b=0.1. If the score is less than 0, then it may be assigned to 0, which is usually 0.75 or above. In this way, the value of barrage fluency may be quantized as 0˜1, where 1 is the optimal score.

Next, the ordinary high traffic layer is used as an example to illustrate the calculation of the performance score. Here, the score of framerate stability (Layer framerate stability) may be defined (with values from 0 to 1):

$$score = ( 1 - a * Layer Framedrop ) * b * \frac{Layer current FPS}{Layer Orignial FPS}$$

Where, Layer Framedrop is the frame drop rate of the application layer, which may be sampled from the display synthesis system, Layer Original FPS is the average frame rate of the target layer before optimizing the refresh rate value of the target layer, Layer current FPS may be the sampled frame rate of the target layer after optimizing the refresh rate value of the target layer; furthermore, Layer current FPS may be the sampled frame rate of the target layer after each optimization of the refresh rate value of the target layer. In this way, the score of the framerate stability of the application layer may be quantized as 0 to 1, where 1 is the optimal score. In general, a lower refresh rate of the application layer may result in a higher frame drop rate, which in turn leads to a lower frame rate stability score.

For two adjustable high power consumption layers, either the special layer or the ordinary high traffic layer, both of their refresh rate values are optimized by learning based on the power consumption score and the performance score.

Below, this optimization learning process is illustrated using the barrage layer as an example. The learning process for the ordinary high traffic layer is similar, except that the type of performance score needs to be chosen as frame rate stability.

First, a SARSA-learning training model may be established. Among them, the process of establishing the SARSA-learning training model may contain six parts, which are: 1. state definition; 2. action definition A; 3. single-step reward (or single-step punishment) R; 4. discounted action value function Q; 5. iterative training process; 6. policy function.

### 1. State Definition

It is assumed that the average sampled current of the terminal before optimizing the refresh rate value of the target layer at the very beginning is rc, the average performance score of the terminal is rf, and the sampled period is 5 s; it is assumed that the target average current to be achieved tc=p*rc, and the target average performance score tf=q*rf, where p, q are the proportionality coefficients; it is assumed that cc is the average sampled current after each optimization of the refresh rate value of the target layer, cf is the average performance score after each optimization, dc is the current factor, and df is the performance score factor.

Then the factor level of the feature may be defined, i.e.:

$$dc = f 1 ( c c ) = f 1 ( cc , rc , tc )$$

$$df = f 2 ( cf ) = f 2 ( cf , rf , tf )$$

Thus the state S may be defined, i.e.:

$$S = s ( dc , df ) = s ( f 1 ( c c ) , f 2 ( cf ) )$$

The average sampled current cc after each optimization is based on the target average current tc that wants to be achieved and the average sampled current rc of the terminal before the optimization is performed at the very beginning as a reference, it is assumed that the segment size of the current

$$bc = \frac{r c - t c}{2} ,$$

i.e., the current may be segmented based on this size. Here, de may be defined as 5 levels, with a smaller dc indicating a larger current gain.

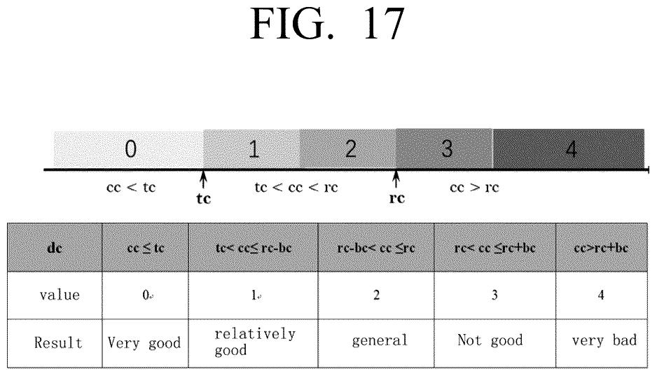

FIG. 17 is a schematic diagram illustrating segmentation of a current and levels of a current factor de according to an embodiment of the disclosure.

Referring to FIG. 17, the current is segmented into a total of 5 segments and the current factor de contains a total of 5 levels.

The average performance score cf after each optimization may be based on the target average performance score tf as a reference, it is assumed that the segment size of the performance score bf=0.1, and the performance score may be segmented based on this size. Here, the performance score factor df may be defined as 4 levels, with a smaller df indicating a larger performance score gain. df is actually a suppression factor that balances the power consumption gain and the performance gain.

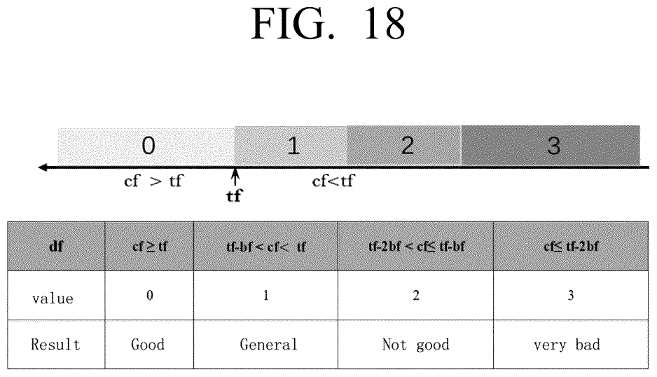

FIG. 18 is a schematic diagram illustrating segmentation of a performance score and levels of a performance score factor df according to an embodiment of the disclosure.

Referring to FIG. 18, the performance score is segmented into a total of 4 segments and the performance score factor df contains a total of 4 levels.

When optimizing the refresh rate value of the target layer, the current may be reduced by at most 40%, thus the aforementioned p, q factors may be defined as 0.6 and 1. For example, while keeping the performance score unchanged, the current consumption may be reduced by 40% as an adjustment target.

Still taking the video app illustrated in FIG. 1 as an example, it is assumed that:

$$rc = 530 mA , rf = 1. , p = 0.6 , q = 1 \text{.0} ,$$

$$⇒ tc = 0.6 ⋆ 530 = 318 mA , tf = 1. ⋆ 1. = 1.0$$

$$⇒ bc = \frac{r c - t c}{2} = \frac{530 - 318}{2} = 106 , bf = 0.1$$

$$State two - tuples S = s ( dc , df ) = s ( f 1 ( cc ) , f 2 ( cf ) )$$

It is noted that in determining the current state before the very first optimization of the refresh rate of the target layer, since the optimization of the refresh rate has not yet started, it may be regarded that cc=rc, cf=rf=tf. At this point, returning to refer to FIG. 17, and since the value of cc at this point falls into the interval of rc−bc<cc≤rc, it is possible to determine that in the current state, i.e., before the very first optimization of the refresh rate of the target layer, dc=2. Referring back to FIG. 18, since the value of cf at this point falls into the interval cf≥tf, it may be determined that in the current state, i.e., before the very first optimization of the refresh rate of the target layer, df=0. Therefore, the current state of the terminal is.

$$s ( dc , df ) = s ( f 1 ( 530 ) , f 2 ( 1.0 ) ) = s ( 2 , 0 )$$

It is assumed that the current after optimizing the refresh rate value of the target layer cc=416 mA, cf=0.95, then at this point:

$$rc - bc = 530 mA - 106 mA = 424 mA ; t c = 0.6 \times 530 = 318 mA ;$$

$$tf = 1. ⋆ 1. ; tf - bf = 1. - 0.1 = 0.9$$

Returning to FIG. 17, since cc=416 mA falls into the interval (318,424], i.e., it falls into the interval (tc, rc−bc] at this point, it may be determined that dc=1 after the optimization of the refresh rate value of the target layer in the present time. Returning to FIG. 18, since cf=0.95 falls into the interval (0.9,1.0], i.e., it falls into the interval (tf−bf, tf] at this point, it may be determined that df=1 after the optimization of the refresh rate value of the target layer in the present time. Therefore, the state of the terminal after the optimization of the refresh rate value of the target layer is.

$$s ( dc , df ) = s ( f 1 ( 416 ) , f 2 ( 0.95 ) ) = s ( 1 , 1 )$$

### 2. Action Definition A

In operation 404, a switching range of the refresh rate value of the target layer is determined as [48 Hz, 60 Hz, 96 Hz, 120 Hz]. The “action definition” in the disclosure means adjusting the refresh rate value by one level, and a total of three action types may be defined.

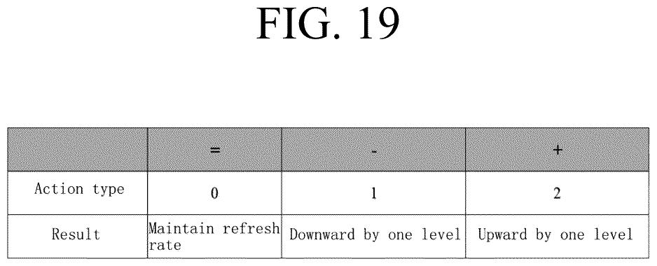

FIG. 19 is a schematic diagram illustrating an action type according to an embodiment of the disclosure.

Referring to FIG. 19, the three action types are: maintaining the current refresh rate, adjusting the refresh rate downward by one level, and adjusting the refresh rate upward by one level.

### 3. Single-Step Reward (or Single-Step Penalty) R

A minimization penalty value function may be used here, and the single-step penalty may be defined in a table, i.e., at a certain state s(dc,df), there is a predetermined penalty value R.

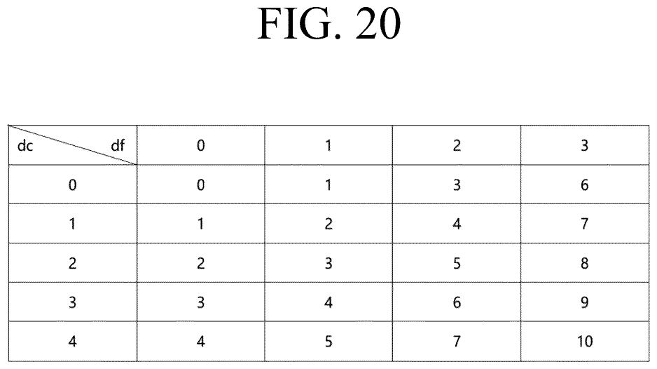

FIG. 20 is a schematic diagram illustrating a table of single-step penalties in accordance with an embodiment of the disclosure.

Referring to FIG. 20, in each state s(dc,df), there corresponds to a predetermined penalty value R. Exemplarily, R(0, 0)=0; R(4,3)=10, and so forth.

It should be noted that when the performance score decreases more, for example, when df=3, the penalty value is higher regardless of how much the current decreases; if the performance score remains unchanged, the penalty value is gradually increased according to the increase of the current.

As mentioned before, the state of the terminal before the very first optimization of the refresh rate value of the target layer is S(2,0), and the corresponding single-step penalty R value is R(S(2,0))=R(2, 0)=2, which indicates that the refresh rate value of the target layer may also be further optimized.

### 4. Discounted Action Value Function Q

Q=Q(S, A)=Q(dc, df, A), the Q-table may be initialized to an all-zero matrix.

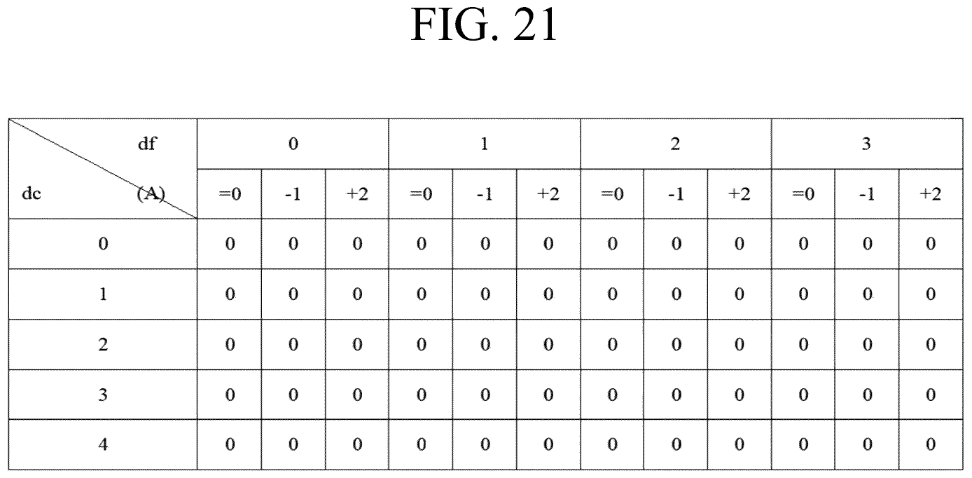

FIG. 21 is a schematic diagram illustrating a Q-table of initialized states according to an embodiment of the disclosure.

Referring to FIG. 21, in each state s(dc,df), there are three actions, each corresponds to a discounted value, i.e., a state action penalty value. Exemplarily, Q(0,0,0)=0. The purpose of learning is to continuously calculate the Q value of the corresponding state in the actual test until it reaches a converged state, i.e., until the floating range of the discounted value in each grid in FIG. 21 is within a preset range. After the Q-table is learned, it may be used to guide the adjustment of the refresh rate value of the target layer in the actual use until it reaches an optimal state.

### 5. Iterative Training Process

The SARSA-learning iterative update formula of this model may be expressed as:

$$Q ( S , A ) = Q ( S , A ) + a * ( R ( {S}^{′} , {A}^{′} ) + r * Q ( {S}^{′} , {A}^{′} ) - Q ( S , A ) )$$

where S=s(dc,df) denotes the current state;

A denotes the action taken, a is the learning rate and r is the discount factor;

S′=s(dc′,df′) denotes the new state reached after taking the action A in the S state;

A′ denotes the action chosen in the new state;

R(S′, A′) is the single-step reward (single-step penalty) for reaching the new state;

Q(S,A) is the reward value of adopting this action A in the current state S (state action penalty value).

It is assumed that a=0.3, r=0.8. As mentioned earlier, the state of the terminal before the very first optimization of the refresh rate value of the target layer is S(2,0). It is assumed that in this state S(2,0), five actions are selected and different states are reached.

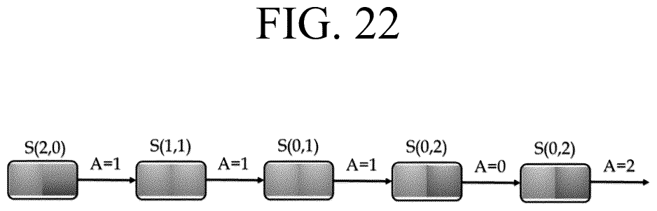

FIG. 22 is a schematic diagram illustrating a Sarsa learning (S, A) state migration according to an embodiment of the disclosure.

The following Q values may be calculated separately:

In the initial state at the very beginning is S(2,0), after performing the action A=1, a new state S′(1,1) is reached, and the next action is also A′=1, then:

$$Q ( 2 , 0 , 1 ) = Q ( 2 , 0 , 1 ) + 0.3 * ( R ( 1 , 1 ) + 0.8 * Q ( 1 , 1 , 1 ) - Q ( 2 , 0 , 1 ) ) = 0 + 0.3 * ( 2 + 0.8 * 0 - 0 ) = 0.6 ;$$

In S(1,1), after performing the action A=1, a new state S′(0,1) is reached, and the next action is also A′=1, then:

$$Q ( 1 , 1 , 1 ) = Q ( 1 , 1 , 1 ) + 0.3 * ( R ( 0 , 1 ) + 0.8 * Q ( 0 , 1 , 1 ) - Q ( 1 , 1 , 1 ) ) = 0 + 0.3 * ( 1 + 0.8 * 0 - 0 ) = 0.3 ;$$

In S(0,1), after performing the action A=1, a new state S′(0,2) is reached, and the next action is A′=0, then:

$$Q ( 0 , 1 , 1 ) = Q ( 0 , 1 , 1 ) + 0.3 * ( R ( 0 , 2 ) + 0.8 * Q ( 0 , 2 , 0 ) - Q ( 0 , 1 , 1 ) ) = 0 + 0.3 * ( 3 + 0.8 * 0 - 0 ) = 0.9 ;$$

In S(0,2), after performing the action A=0, the new state is still S′(0,2), and the next action is A′=2, then:

$$Q ( 0 , 2 , 0 ) = Q ( 0 , 2 , 0 ) + 0.3 * ( R ( 0 , 2 ) + 0.8 * Q ( 0 , 2 , 2 ) - Q ( 0 , 2 , 1 ) ) = 0 + 0.3 * ( 3 + 0.8 * 0 - 0 ) = 0.9 .$$

After the above five actions, the data in the Q-table is updated.

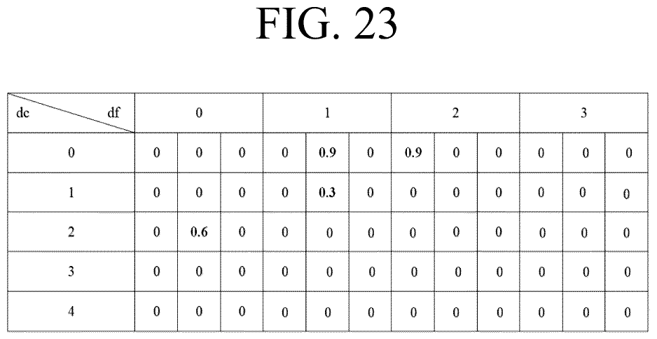

FIG. 23 is a schematic diagram illustrating a Sarsa learning Q-table after it has been updated according to an embodiment of the disclosure.

Referring to FIG. 23, at this point, the value of Q(2,0,1) is updated from 0 to 0.6; the value of Q(1,1,1) is updated from 0 to 0.3; the value of Q(0,1,1) is updated from 0 to 0.9; and the value of Q(0,2,0) is updated from 0 to 0.9.

By parity of reasoning, after continuous iterative updating, the above data of the Q-table will gradually fill and iteratively converge, that is, the data change is very small, that is, the data in each state-action Q(S, A) will converge to a final state-action penalty value.

### 6. Policy Function

The policy function here is used to guide how to select the next action type when the Q-table trained over a time period reaches a new state, i.e., to explore how to get the most optimal training result. The policy function used here should be both exploratory and greedy.

It should be noted that a random number p may be taken using the &-greedy method:

$$p = Rand ( ) ( 0 \leq p < 1 )$$

It is assumed that a threshold is &, then:

When p<=ε, the selected action type may be the optimal action, i.e., the one that corresponds to the state action with the smallest penalty value;

When p>ε, a random action type may be selected for exploration.

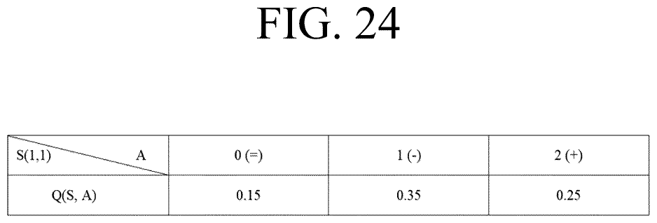

Exemplarily, it is assumed that the Q value in the S(1,1) state after a period of training is shown in FIG. 24.

FIG. 24 is a schematic diagram illustrating a Q value in a S(1,1) state according to an embodiment of the disclosure.

Referring to FIG. 24, the Q values (state action penalty values) in the S(1,1) state contain a total of three, which are 0.15, 0.35, and 0.25, respectively.

When training again into this state S(1,1), it is assumed that ε=0.3, the random number is taken as p=Rand( ).

If p=0.2, since p=0.2<ε=0.3, the action type that corresponds to the state action with the smallest penalty value may be selected, i.e., the action type A=0 may be selected that corresponds to the state action with a penalty value of 0.15;

If p=0.5, since p=0.5>ε=0.3, an action type may be randomly selected, i.e., A=Rand (2)=U(0, 1,2), i.e., an action type may be randomly selected among the three action types [0,1,2].

It should be noted that it may be set that when the training iteration reaches a certain level, the strategy of p<=ε may be taken directly, that is, the action type corresponding to the state action with the smallest penalty value may be taken directly, that is, the action type corresponding to

$${min}_{A = 0 , 1 , 2} \{ Q ( S , A ) \}$$

may be taken directly.

According to an embodiment of the disclosure, power consumption and performance state data s(dc,df) of the terminal may be obtained. Then, the refresh rate value of the target layer may be optimized based on the power consumption and performance state data s(dc,df) of the terminal by means of a reinforcement learning model, i.e., by means of the Q-table completed by training. Next, an optimized refresh rate value of the terminal screen may be determined based on the optimized refresh rate value of the target layer. Then, the target application may be run based on the optimized refresh rate value of the terminal screen.

In this way, since the converged Q-table is obtained after a large amount of training, it is instructive for the actual optimization process of the refresh rate value, and it may ensure that the optimized refresh rate value obtained after optimization achieves a better balance between the terminal power consumption and the terminal performance.

According to an embodiment of the disclosure, the refresh rate value of the target layer may be optimized based on the power consumption and performance state data s(dc,df) of the terminal and the preset state action table of the reinforcement learning model, and the optimized refresh rate value of the target layer may be obtained. Wherein, the preset state action table, i.e., the Q-table, may include a plurality of states s(dc,df), each of which may have a plurality of refresh rate adjustment action types. Exemplarily, each state may correspond to three refresh rate adjustment action types, respectively: 0 (which indicates maintaining the refresh rate), 1 (which indicates adjusting the refresh rate downwards by one level), and 2 (which indicates adjusting the refresh rate upwards by one level). Each refresh rate adjustment action type may correspond to a respective state action penalty value (Q value).

Exemplarily, as described previously, the state of the terminal before the refresh rate value of the target layer is optimized at the very beginning is S(2,0), it is assumed that the refresh rate value of the target layer before the refresh rate value is optimized at the very beginning is 48 Hz, the average sampled current of the terminal before the optimization is optimized at the very beginning is rc, and the average performance score of the terminal before the optimization is optimized at the very beginning is rf.

First, the action type with the smallest state action penalty value among the three action types under the state S(dc,df)=S(2,0) may be found from the trained Q-table, based on the initial state S(2,0) at the very beginning and the trained Q-table. It is assumed that the action type with the smallest state action penalty value is 2, i.e., “adjusting the refresh rate upwards by one level”, and the refresh rate value may be adjusted one level upward based on 48 Hz according to this action type 2.

It should be noted that when adjusting the refresh rate value of the target layer, it is necessary to adjust it between the refresh rate levels supported by the terminal screen. As mentioned earlier, there are seven refresh rate levels supported by a certain type of terminal, namely: [10 Hz, 24 Hz, 30 Hz, 48 Hz, 60 Hz, 96 Hz, 120 Hz], and therefore, the refresh rate value of the target layer may only be adjusted by selecting between these seven refresh rate levels. As mentioned earlier, by adjusting the refresh rate value by one level upward based on 48 Hz, the refresh rate value of the target layer is adjusted from 48 Hz to 60 Hz.

Then, the average sampled current cc and the average performance score cf of the terminal after adjusting the refresh rate value of the target layer at this time may be obtained. The state S′(dc,df) of the terminal after adjusting the refresh rate value of the target layer at this time may be determined based on the average sampled current rc of the terminal before optimizing at the very beginning, the average performance score rf of the terminal before optimizing at the very beginning, the average sampled current cc of the terminal after adjusting the refresh rate value of the target layer at this time, the average performance score cf of the terminal after adjusting the refresh rate value of the target layer at this time, the schematic illustration of the segmentation of the current and the level of the current factor de illustrated in FIG. 17, and the schematic illustration of the segmentation of the performance score and the level of the performance score factor df illustrated in FIG. 18.

Next, the action type with the smallest state action penalty value (Q value) among the three action types under the state S′(dc,df) may be found from the trained Q-table, based on the state S′(dc,df) and the trained Q-table. It is assumed that the action type with the smallest state action penalty value is 2, i.e., “adjusting the refresh rate upwards by one level”, and the refresh rate value may be adjusted upward by one level based on 60 Hz according to this action type 2, and at this time, the refresh rate value of the target layer is adjusted to 96 Hz.

Then, the average sampled current cc and the average performance score cf of the terminal after adjusting the refresh rate value of the target layer at this time may be obtained. The state S″ (dc,df) of the terminal after adjusting the refresh rate value of the target layer at this time may be determined based on the average sampled current rc of the terminal before optimizing at the very beginning, the average performance score rf of the terminal before optimizing at the very beginning, the average sampled current cc of the terminal after adjusting the refresh rate value of the target layer at this time, the average performance score cf of the terminal after adjusting the refresh rate value of the target layer at this time, the schematic illustration of the segmentation of the current and the level of the current factor de illustrated in FIG. 17, and the schematic illustration of the segmentation of the performance score and the level of the performance score factor df illustrated in FIG. 18. And so on, until the action type with the smallest state action penalty value among the three action types under the current stateS_{current}(dc, df) of the terminal found from the trained Q-table based on the current state S_{current}(dc, df) and the trained Q-table is “maintaining the refresh rate unchanged”. At this point, the obtained refresh rate value of the target layer is the better refresh rate value that balances the power consumption and the performance of the terminal.

In this way, since the preset state action table of the reinforcement learning model records the state action penalty value corresponding to each action type of the multiple action types in each of the multiple states, the optimal action that should be performed in the current state may be found by simply querying the trained Q-table using the current state of the terminal. Moreover, the optimal refresh rate value that balances the power consumption and performance of the terminal may be found by a finite number of queries. Running the target application based on the optimal refresh rate value may substantially reduce the power consumption of the terminal, and at the same time, it may also ensure that the video playback quality is not affected, i.e., it may ensure a smooth viewing experience, and avoid flickering and lagging phenomena on the terminal screen.

As previously mentioned, the refresh rate value of the video layer in the four application layers included in the video APP illustrated in FIG. 1 is 24 Hz, and the refresh rate value of the barrage layer is 120 Hz. In accordance with prior art, the refresh rate of the system is:

System Refresh Rate=max{24, 120}=120 Hz, and the working current of the terminal is high.

In the disclosure, it is assumed that the refresh rate value of the target layer obtained by the final optimization is 48 Hz, System Refresh Rate=max{24, 48}=48 Hz when the frame rate of the video source is 24 Hz, which provides more current improvement and unchanged performance compared to the prior art;

When the frame rate of the video source is 30 Hz, System Refresh Rate=max{30, 48}=48 Hz, which provides more current improvement and unchanged performance compared to the prior art;

When the frame rate of the video source is 60 Hz, System Refresh Rate=max{60, 48}=60 Hz, which provides more current improvement and unchanged performance compared to the prior art;

When the frame rate of the video source is 120 Hz, System Refresh Rate=max{120, 48}=120 Hz, with unchanged performance compared to the prior art.

It should be noted that in the related art, manually enforcing the refresh rate of the app may change the playback quality of the video. Whereas in the disclosure, the setting of the refresh rate does not change the playback quality of the video, but only reduces the high current problem it causes. However, the terminal screen will still run in a high frame rate mode if the video source is a high frame rate video, but at this point it is not the cause of the increased current. From the experimental results, the power consumption and heat generation of a special layer (barrage layer) may be generally reduced by about 20˜30%, and the power consumption of the ordinary high traffic layer may be reduced by about 8%˜20%, while the performance is basically unchanged.

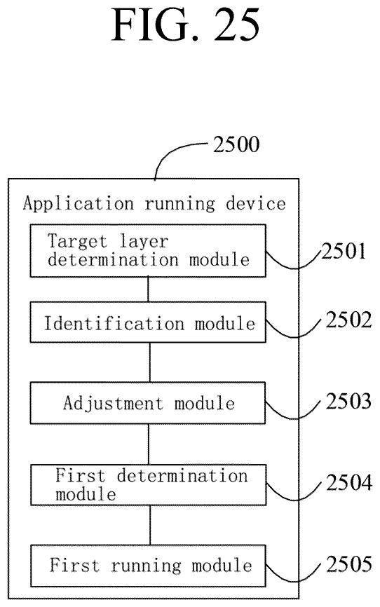

FIG. 25 is a block diagram illustrating a device of running an application according to an embodiment of the disclosure.

Referring to FIG. 25, a device 2500 may include a target layer determination module 2501, an identification module 2502, an adjustment module 2503, a first determination module 2504, and a first running module 2505.

The target layer determination module 2501 may determine a target application for improving power consumption and a target layer of the target application for improving refresh rate. Wherein, the target application may include a plurality of application layers, and each application layer is used to implement its specific function.

According to an embodiment of the disclosure, the target layer determination module 2501 may obtain historical behavioral characteristic data of foreground running of each application installed within the terminal, thereby determining, as the target application, an application whose historical behavioral characteristic data is outside a predetermined range. In this way, the apps may be filtered by the historical behavioral characteristic data of foreground running of the apps, which may get the apps that are worth to be optimized. The phenomenon of ineffective optimization for a large number of apps that are not worth to be optimized is avoided, and optimization resources may be saved.

According to an embodiment of the disclosure, while the target application is running, the target layer determination module 2501 may obtain the running behavior characteristic data of the target application. In the case where the running behavior characteristic data exceeds a preset range, the target layer determination module 2501 may determine an application layer corresponding to the highest actual sampled refresh rate value among the plurality of application layers included in the target application as the target layer. Wherein, the “running behavior characteristic data” may include at least one of “a running average current TH_{app average current}”, “a total running power consumed by the video-related service module of the app TH_{app video total drain}”, “a current refresh rate of the terminal screen TH_{system refresh rate}”.

The identification module 2502 is mainly used to identify a type of the target layer based on a decision tree model.

According to an embodiment of the disclosure, the above identification module 2502 is specifically used to obtain the layer display behavioral characteristic data of the target layer of the target application for a predetermined time period, and then input the layer display behavioral characteristic data into the decision tree model to identify the type of the target layer. Wherein, the decision tree model may be, but is not limited to, a C4.5 decision tree model.

According to an embodiment of the disclosure, the layer display behavioral characteristic data may include at least one of: a position of the target layer on a Z-axis, a percentage of an area of the target layer to an area of the terminal screen, a transparency of the target layer, whether the target layer corresponds to a specific keyword, whether the target layer belongs to a preset surface view layer type, a content density of the target layer, a horizontal scroll step density of the target layer, a refresh rate value of the target layer, content traffic of the target layer.

According to an embodiment of the disclosure, the application layers may be pre-classified into a plurality of types based on power consumption, and predetermined at least one of the plurality of types may be set to be the power consumption adjustable layer.

According to an embodiment of the disclosure, the application layers may be pre-classified into a plurality of types based on power consumption, such as, but not limited to, a high power consumption layer (which may also be referred to as a high process volume) and a low power consumption layer (which may also be referred to as a low process volume). Additionally, the high power consumption layer and the low power consumption layer may be further classified based on the content of the display, e.g., the high power consumption layer may be classified as, but is not limited to, a content layer and a comment information layer. By way of example, the high power consumption layer may be classified into a first type and a second type, i.e., the first type may be an application layer for displaying substantial content of the target application, which may also be referred to as a general high traffic layer. Exemplarily, this may be a video layer/game layer; the second type may be an application layer for displaying comment information related to the substantive content, exemplarily, this may be a barrage layer. Both types may be set as the power consumption adjustable layers due to high current consumption. In addition, the low power consumption layer may be a third type, which may also be called a general low traffic layer, and usually the current consumption due to this type is relatively low, and thus may not be set as the power consumption adjustable layer. Of course, the classification of the application layer is not limited to the above example, but may also be made based on the actual power consumption or functional state, and the foregoing classification is merely an exemplary illustration.

According to an embodiment of the disclosure, the above identification module 2502 may acquire the layer display behavioral characteristic data of the target layer at a preset time interval during the predetermined time period, to obtain a plurality of sets of layer display behavioral characteristic data corresponding to the target layer. Exemplarily, the layer display behavioral characteristic data of the target layer may be collected every 5 seconds for 30 consecutive times, and a total of 30 sets of layer display behavioral characteristic data may be obtained.

According to an embodiment of the disclosure, the above identification module 2502 may input each of the plurality of sets of layer display behavioral characteristic data corresponding to the target layer into the decision tree model, respectively, to obtain an identification result corresponding to each of the plurality of sets of layer display behavioral characteristic data. Exemplarily, the 30 sets of layer display behavioral characteristic data may be input into the decision tree model, respectively, to obtain the identification results corresponding to each set of layer display behavioral characteristic data.

Next, in the case where the plurality of sets of identification results corresponding to the plurality of sets of layer display behavioral characteristic data all indicate that the target layer is a power consumption adjustable layer, the target layer may be determined to be the power consumption adjustable layer. Exemplarily, in the case where the 30 sets of identification results corresponding to the 30 sets of layers displaying the behavioral characteristic data all indicate that the target layer is the power consumption adjustable layer, it may be determined that the target layer is the power consumption adjustable layer. In this way, since the plurality of sets of collected data are used for identification, the probability of misjudgment may be greatly reduced, and the accuracy of identification of the type of the target layer may be ensured

The adjustment module 2503 may adjust a refresh rate value of the target layer based on the type of the target layer corresponding to a power consumption adjustable layer. For example, in the case where the type of the target layer belongs to an adjustable high power consumption layer (special layer, ordinary high traffic layer), the refresh rate value of the target layer may be adjusted.

According to an embodiment of the disclosure, the adjustment module 2503 may adjust the refresh rate value of the target layer based on at least one of a center position relationship between the target layer and the terminal screen, an area relationship between the target layer and the terminal screen, and the type of the target layer.

It should be noted that, from the visual experience, it may be considered that the closer the center position of the application layer is to the center position of the screen, the higher its refresh rate may be; or, the larger the ratio of the area of the application layer to the area of the terminal screen, i.e., the larger the area of the application layer accounts for, the higher the refresh rate of the application layer may be; or, the type of the application layer is different, and so is its refresh rate. For example, the refresh rate of the barrage layer is generally higher than that of the video layer and so on. In this way, by adjusting the refresh rate value of the target layer through combining the multiple dimensions of characteristics, the accuracy of the adjustment of the refresh rate value may be ensured.

According to an embodiment of the disclosure, the adjustment module 2503 may determine a preset minimum refresh rate value corresponding to the target layer based on at least one of the center position relationship between the target layer and the terminal screen, the area relationship between the target layer and the terminal screen, and the type of the target layer. Then, the adjustment module 2503 may adjust the refresh rate value of the target layer based on the preset minimum refresh rate value corresponding to the target layer and an actual sampled refresh rate value of the target layer. In this way, by adjusting the refresh rate value of the target layer based on the preset minimum refresh rate value and the actual sampled refresh rate value, the objectivity of adjustment of the refresh rate value may be ensured. Moreover, since the determined refresh rate value is a range interval, the phenomenon of directly taking the actual sampled frame rate of the target layer as its final refresh rate value and causing the refresh rate of the system to be forcibly pulled up may be avoided, thereby avoiding excessive power consumption of the terminal, and resources may be saved.

The first determination module 2504 may determine a refresh rate value of a terminal screen based on the adjusted refresh rate value of the target layer.

According to an embodiment of the disclosure, the first determination module 2504 may determine the refresh rate value of the terminal screen based on the adjusted refresh rate value of the target layer and actual sampled refresh rate value(s) of other layer(s) included in the target application. In this way, in determining the refresh rate value of the terminal screen, the adjusted refresh rate value of the target layer and the actual sampled refresh rate values of the other application layers are taken into account, thus it may be ensured that the power consumption of the terminal may be reduced, and it may be ensured that the performance of the terminal is basically unchanged.

The first running module 2505 may run the target application based on the refresh rate value of the terminal screen.

According to an embodiment of the disclosure, a state data acquisition module may obtain power consumption and performance state data s(dc, df) of the terminal. Then, the optimization module may optimize the refresh rate value of the target layer based on the power consumption and performance state data s(dc, df) of the terminal by means of a reinforcement learning model, i.e., by means of the trained Q-table. Next, the second determination module may determine an optimized refresh rate value of the terminal screen based on the optimized refresh rate value of the target layer. And the second running module may run the target application based on the optimized refresh rate value of the terminal screen.

In this way, since the converged Q-table is obtained after a large amount of training, it is instructive for the actual optimization process of the refresh rate value, and it may ensure that the optimized refresh rate value obtained after optimization achieves a better balance between the terminal power consumption and the terminal performance.

According to an embodiment of the disclosure, the optimization module may optimize the refresh rate value of the target layer based on the power consumption and performance state data s(dc,df) of the terminal and the preset state action table of the reinforcement learning model, and obtain the optimized refresh rate value of the target layer. Wherein, the preset state action table, i.e., the Q-table, may include a plurality of states s(dc,df), each of which may have a plurality of refresh rate adjustment action types. Exemplarily, each state may correspond to three refresh rate adjustment action types, respectively: 0 (which indicates maintaining the refresh rate), 1 (which indicates adjusting the refresh rate downwards by one level), and 2 (which indicates adjusting the refresh rate upwards by one level). Each refresh rate adjustment action type may correspond to a respective state action penalty value (Q value).

In this way, since the preset state action table of the reinforcement learning model records the state action penalty value corresponding to each action type of the multiple action types in each of the multiple states, the optimal action that should be performed in the current state may be found by simply querying the trained Q-table using the current state of the terminal. Moreover, the optimal refresh rate value that balances the power consumption and performance of the terminal may be found by a finite number of queries. Running the target application based on the optimal refresh rate value may substantially reduce the power consumption of the terminal, and at the same time, it may also ensure that the video playback quality is not affected, i.e., it may ensure a smooth viewing experience, and avoid flickering and lagging phenomena on the terminal screen.

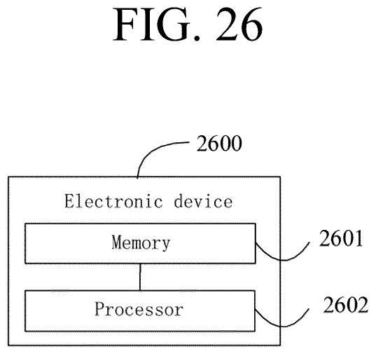

FIG. 26 is a block diagram illustrating an electronic device according to an embodiment of the disclosure.

Referring to FIG. 26, an electronic device 2600 includes at least one memory 2601 and at least one processor 2602, the at least one memory 2601 having instructions stored therein, which, when executed by the at least one processor 2602, performs a method of running an application according to embodiments of the disclosure.

As an example, the electronic device 2600 may be a personal computer (PC) computer, a tablet device, a personal digital assistant, a smart phone, or any other device capable of executing the above instructions. Here, the electronic device 2600 does not have to be a single electronic device, but may also be any set of devices or circuits capable of executing the above instructions (or instruction set) individually or jointly. The electronic device 2600 may also be a part of an integrated control system or system manager, or may be configured as a portable electronic device that interfaces locally or remotely (e.g., via wireless transmission).

In the electronic device 2600, the processor 2602 may include a central processing unit (CPU), a graphics processor (GPU), a programmable logic device, a dedicated processor system, a microcontroller, or a microprocessor. By way of example and not limitation, the processor may also include an analog processor, a digital processor, a microprocessor, a multi-core processor, a processor array, a network processor, and the like.

The processor 2602 may run instructions or code stored in the memory 2601, wherein the memory 2601 may also store data. The instructions and data may also be sent and received over a network via a network interface device, wherein the network interface device may utilize any known transmission protocol.

The memory 2601 may be integrated with the processor 2602, e.g., RAM or flash memory is arranged within an integrated circuit microprocessor or the like. Additionally, the memory 2601 may include a separate device, such as an external disk drive, storage array, or any other storage device that may be used by a database system. The memory 2601 and the processor 2602 may be operatively coupled, or may communicate with each other, e.g., through input/output (I/O) ports, network connections, or the like, to enable the processor 2602 to read files stored in the memory 2601.

In addition, the electronic device 2600 may also include video displays (e.g., liquid crystal display) and user interaction interfaces (e.g., keyboard, mouse, touch input device, or the like). All components of the electronic device 2600 may be connected to each other via a bus and/or a network.

Furthermore, an artificial intelligence model may be used to perform the above method of running an application performed by the electronic device 2600. At this point, at least one of the plurality of modules included in the electronic device 2600 may be realized by an artificial intelligence (AI) model. Functions associated with AI may be performed by non-volatile memory, volatile memory, and a processor.

The processor may include one or more processors. At this time, one or more processors may be general-purpose processors, such as central processing units (CPUs), application processors (APs), or the like, processors only used for graphics, such as graphics processors (GPUs), vision processors (VPU), and/or AI-specific processors, such as neural processing units (NPUs).

One or more processors control processing of inputting data according to predefined operating rules or artificial intelligence (AI) models stored in the non-volatile memory and the volatile memory. As an example, the predefined operating rules or the artificial intelligence models may be provided through training or learning. Here, providing by learning means that by applying a learning algorithm to a plurality of learning data, a predefined operating rule or AI model with desired properties is formed. Learning may be performed in an AI executing device itself according to an embodiment of the disclosure, and/or may be implemented by a separate server/device/system.

As an example, an artificial intelligence model may consist of a plurality of neural network layers. Each layer has a plurality of weight values, and performs a layer operation by a calculation of a previous layer and an operation of the plurality of weight values. Examples of neural networks include, but are not limited to, convolutional neural networks (CNNs), deep neural networks (DNNs), recurrent neural networks (RNNs), restricted boltzmann machines (RBMs), deep belief networks (DBNs), bidirectional recurrent deep neural networks (BRDNNs), generative adversarial networks (GANs), and deep Q-networks.

A learning algorithm is a method of using a plurality of learning data to train a predetermined target device (e.g., a robot) to cause, allow or control the target device to make a determination or prediction. Examples of the learning algorithm include, but are not limited to, supervised learning, unsupervised learning, semi-supervised learning, or reinforcement learning.

According to an embodiment of the disclosure, a computer readable storage medium is also provided. Instructions in the computer readable storage medium, when executed by a processor of an electronic device, cause the processor to perform the above method of running an application. Examples of computer-readable storage media herein include read only memory (ROM), random access programmable read only memory (RAPROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, hard disk drive (HDD), solid state drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device. In addition, in one example, the computer programs and any associated data, data files, and data structures are distributed on a networked computer system, so that the computer programs and any associated data, data files, and data structures are stored, accessed and executed through one or more processors or computers in a distributed manner.

The method of running an application, the apparatus, the electronic device and the storage medium of the disclosure may identify the type of a target layer whose refresh rate is to be improved by utilizing the decision tree model, and in the case that the type of the target layer belongs to the power consumption adjustable layer, may automatically adjust the refresh rate value of the target layer, which may in turn affect the change of the refresh rate value of the terminal screen. In this way, it may be realized that the refresh rate of the system may be avoided to be forcibly pulled up, and the phenomenon of the working current of the terminal being higher due to the refresh rate of the system being forcibly pulled up and thus causing the power consumption of the terminal to be too large may be avoided, and more resources may be saved. Moreover, since the disclosure does not require manual setting of the corresponding refresh rate for different APPs one by one, i.e., the whole process does not require manual intervention; it avoids the repetitive and cumbersome setting process and makes the setting of the refresh rate more intelligent and convenient.

Further, the apps may be filtered by the historical behavioral characteristic data of foreground running of the apps, which may get the apps that are worth to be optimized. The phenomenon of ineffective optimization for a large number of apps that are not worth to be optimized is avoided, and optimization resources may be saved.

Further, since the plurality of sets of collected data are used for identification, the probability of misjudgment may be greatly reduced, and the accuracy of identification of the type of the target layer may be ensured.

Further, by adjusting the refresh rate value of the target layer through combining multiple dimensions of the characteristics, the accuracy of the adjustment of the refresh rate value may be ensured.

Further, by adjusting the refresh rate value of the target layer based on the preset minimum refresh rate value and the actual sampled refresh rate value, the objectivity of adjustment of the refresh rate value may be ensured. Moreover, since the determined refresh rate value is a range interval, the phenomenon of directly taking the actual sampled frame rate of the target layer as its final refresh rate value and causing the refresh rate of the system to be forcibly pulled up may be avoided, thereby avoiding excessive power consumption of the terminal, and resources may be saved.

Further, in determining the refresh rate value of the terminal screen, the adjusted refresh rate value of the target layer and the actual sampled refresh rate values of the other application layers are taken into account, thus it may be ensured that the power consumption of the terminal may be reduced, and it may be ensured that the performance of the terminal is basically unchanged.

Further, since the converged Q-table is obtained after a large amount of training, it is instructive for the actual optimization process of the refresh rate value, and it may ensure that the optimized refresh rate value obtained after optimization achieves a better balance between the terminal power consumption and the terminal performance.

Further, since the preset state action table of the reinforcement learning model records the state action penalty value corresponding to each action type of the multiple action types in each of the multiple states, the optimal action that should be performed in the current state may be found by simply querying the trained Q-table using the current state of the terminal. Moreover, the optimal refresh rate value that balances the power consumption and performance of the terminal may be found by a finite number of queries. Running the target application based on the optimal refresh rate value may substantially reduce the power consumption of the terminal, and at the same time, it may also ensure that the video playback quality is not affected, i.e., it may ensure a smooth viewing experience, and avoid flickering and lagging phenomena on the terminal screen.

After considering the specification and the practice of the disclosure herein, those skilled in the art will readily conceive of other implementations of the disclosure. The disclosure is intended to cover any variation, use or adaptation of the disclosure that follows the general principles of the disclosure and includes the common knowledge or customary technical means in the field of technology not disclosed by the disclosure. The specification and embodiments are deemed to be exemplary only, and the true scope and spirit of the disclosure are indicated by the appended claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and the scope of the disclosure as defined by the appended claims and their equivalents.

What is claimed is:

1. A method of running an application, the method comprising:
determining a target application for improving power consumption and a target layer of the target application for improving refresh rate;
identifying a type of the target layer based on a decision tree model;
adjusting a refresh rate value of the target layer based on the type of the target layer corresponding to a power consumption adjustable layer;
determining a refresh rate value of a terminal screen based on the adjusted refresh rate value of the target layer; and
running the target application based on the refresh rate value of the terminal screen.

2. The method of claim 1, wherein the adjusting the refresh rate value of the target layer comprises:
adjusting the refresh rate value of the target layer based on at least one of a center position relationship between the target layer and the terminal screen, an area relationship between the target layer and the terminal screen, and the type of the target layer.

3. The method of claim 2, wherein the adjusting the refresh rate value of the target layer comprises:
determining a preset minimum refresh rate value corresponding to the target layer based on at least one of the center position relationship between the target layer and the terminal screen, the area relationship between the target layer and the terminal screen, and the type of the target layer; and
adjusting the refresh rate value of the target layer based on the preset minimum refresh rate value corresponding to the target layer and an actual sampled refresh rate value of the target layer.

4. The method of claim 1, wherein after running the target application based on the refresh rate value of the terminal screen, further comprising:
obtaining power consumption and performance state data of a terminal;
optimizing, by a reinforcement learning model, the refresh rate value of the target layer based on the power consumption and the performance state data of the terminal;
determining an optimized refresh rate value of the terminal screen based on the optimized refresh rate value of the target layer; and
running the target application based on the optimized refresh rate value of the terminal screen.

5. The method of claim 4,
wherein the optimizing, by the reinforcement learning model, the refresh rate value of the target layer based on the power consumption and the performance state data of the terminal comprises:
optimizing the refresh rate value of the target layer based on the power consumption and the performance state data of the terminal and a preset state action table of the reinforcement learning model, to obtain the optimized refresh rate value of the target layer, and
wherein the preset state action table comprises a plurality of states, each of the states corresponds to a plurality of refresh rate adjusting action types, and each of the refresh rate adjusting action types corresponds to a respective state action penalty value.

6. The method of claim 1, wherein the determining the refresh rate value of the terminal screen based on the adjusted refresh rate value of the target layer comprises:
determining the refresh rate value of the terminal screen based on the adjusted refresh rate value of the target layer and actual sampled refresh rate value(s) of other layer(s) included in the target application.

7. The method of claim 4, wherein the determining the target application for improving power consumption comprises:
obtaining historical behavioral characteristic data of foreground running of each application installed within the terminal; and
determining, as the target application, an application whose historical behavioral characteristic data is outside a predetermined range.

8. The method of claim 1, wherein the determining the target layer of the target application for improving refresh rate comprises:
obtaining, while the target application is running, running behavioral characteristic data of the target application; and
determining, based on the running behavioral characteristic data being outside a preset range, an application layer of the highest actual sampled refresh rate value among a plurality of application layers included in the target application as the target layer.

9. The method of claim 1, wherein the identifying the type of the target layer using the decision tree model comprises:
obtaining layer display behavioral characteristic data of the target layer of the target application for a predetermined time period; and
inputting the layer display behavioral characteristic data into the decision tree model to identify the type of the target layer.

10. The method of claim 9, wherein the obtaining the layer display behavioral characteristic data of the target layer of the target application for the predetermined time period comprises:
acquiring the layer display behavioral characteristic data of the target layer at a preset time interval during the predetermined time period, to obtain a plurality of sets of layer display behavioral characteristic data corresponding to the target layer.

11. The method of claim 10, wherein the inputting the layer display behavioral characteristic data into the decision tree model to identify the type of the target layer comprises:
inputting each of the plurality of sets of layer display behavioral characteristic data corresponding to the target layer into the decision tree model, respectively, to obtain a plurality of identification results corresponding to each of the plurality of sets of layer display behavioral characteristic data; and
determining the target layer to be the power consumption adjustable layer based on the plurality of identification results corresponding to the plurality of sets of layer display behavior characteristic data all indicating that the target layer is the power consumption adjustable layer.

12. The method of claim 9, wherein the layer display behavioral characteristic data comprises at least one of:
a position of the target layer on a Z-axis, a percentage of an area of the target layer to an area of the terminal screen, a transparency of the target layer, whether the target layer corresponds to a specific keyword, whether the target layer belongs to a preset surface view layer type, a content density of the target layer, a horizontal scroll step density of the target layer, a refresh rate value of the target layer, content traffic of the target layer.

13. The method of claim 1, wherein layers are pre-classified into a plurality of types based on power consumption, and predetermined at least one of the plurality of types is set to be the power consumption adjustable layer.

14. The method of claim 13,
wherein the plurality of types comprises a first type, a second type and a third type, the first type and the second type are set as the power consumption adjustable layer,
wherein the first type is a layer for displaying substantive content of the target application,
wherein the second type is a layer for displaying comment information related to the substantive content, and
wherein the third type is a layer type other than the first type and the second type included in the application.

15. An electronic apparatus for running an application, the electronic apparatus comprising:
memory, comprising one or more storage media, storing instructions; and
at least one processor communicatively coupled to the memory,
wherein the instructions, when executed by the at least one processor individually or collectively, cause the electronic apparatus to:
determine a target application for improving power consumption and a target layer of the target application for improving refresh rate,
identify a type of the target layer based on a decision tree model,
adjust a refresh rate value of the target layer based on the type of the target layer corresponding to a power consumption adjustable layer,
determine a refresh rate value of a terminal screen based on the adjusted refresh rate value of the target layer, and
run the target application based on the refresh rate value of the terminal screen.

16. The electronic apparatus of claim 15, wherein the instructions, when executed by the at least one processor individually or collectively, further cause the electronic apparatus to:
adjust the refresh rate value of the target layer based on at least one of a center position relationship between the target layer and the terminal screen, an area relationship between the target layer and the terminal screen, and the type of the target layer.

17. The electronic apparatus of claim 16, wherein the instructions, when executed by the at least one processor individually or collectively, further cause the electronic apparatus to:
determine a preset minimum refresh rate value corresponding to the target layer based on at least one of the center position relationship between the target layer and the terminal screen, the area relationship between the target layer and the terminal screen, and the type of the target layer, and
adjust the refresh rate value of the target layer based on the preset minimum refresh rate value corresponding to the target layer and an actual sampled refresh rate value of the target layer.

18. The electronic apparatus of claim 15, wherein the instructions, when executed by the at least one processor individually or collectively, further cause the electronic apparatus to:
obtain power consumption and performance state data of a terminal,
optimize, by a reinforcement learning model, the refresh rate value of the target layer based on the power consumption and the performance state data of the terminal,
determine an optimized refresh rate value of the terminal screen based on the optimized refresh rate value of the target layer, and
run the target application based on the optimized refresh rate value of the terminal screen.

19. One or more non-transitory computer-readable storage media storing one or more computer programs including computer-executable instruction that, when executed by one or more processors of an electronic apparatus individually or collectively, cause the electronic apparatus to perform operations, the operations comprising:
determining a target application for improving power consumption and a target layer of the target application for improving refresh rate;
identifying a type of the target layer based on a decision tree model;
adjusting a refresh rate value of the target layer based on the type of the target layer corresponding to a power consumption adjustable layer;
determining a refresh rate value of a terminal screen based on the adjusted refresh rate value of the target layer; and
running the target application based on the refresh rate value of the terminal screen.

20. The one or more non-transitory computer-readable storage media of claim 19, the operations further comprising:
adjusting the refresh rate value of the target layer based on at least one of a center position relationship between the target layer and the terminal screen, an area relationship between the target layer and the terminal screen, and the type of the target layer.
